(19) United States
(12) Patent Application Publication
(10) Pub. No.: US 2026/0343401 A1
(43) Pub. Date: Oct. 29, 2026

(54) METHODS AND APPARATUS FOR ENABLING WTRU COLLABORATION AND AGGREGATION FOR PLMN SELECTION AND CELL SELECTION AND RESELECTION

(71) Applicant: InterDigital Patent Holdings, Inc., Wilmington, DE (US)

(72) Inventors: Virgile GARCIA, Antibes (FR); Pascal ADJAKPLE, Great Neck, NY (US); Ravikumar PRAGADA, Warrington, PA (US); Umer SALIM, Vallauris (FR); Guodong ZHANG, Woodbury, NY (US); Kyle Jung-Lin PAN, Saint James, NY (US); Yifan LI, Conshohocken, PA (US)

(73) Assignee: InterDigital Patent Holdings, Inc., Wilmington, DE (US)

(21) Appl. No.: 19/487,946

(22) PCT Filed: May 24, 2024
(86) PCT No.: PCT/US2024/031046

§ 371 Date: Nov. 25, 2025

Related U.S. Application Data
(60) Provisional application No. 63/506,250, filed on Jun. 5, 2023.

(51) Int. Cl. H04W 48/20; H04W 24/08

(52) U.S. Cl. CPC H04W 48/20; H04W 24/08

(57) ABSTRACT

A first WTRU may be part of a group of a plurality of WTRUs. The first WTRU may receive, from another WTRU in the group, capability and configuration information associated with measurement collaboration. The first WTRU may select a second WTRU to perform measurement collaboration. The first WTRU may send, to the second WTRU, a request for measurement collaboration for cell selection or reselection. The request may be sent using a sidelink RRC message. The first WTRU may receive, from the second WTRU, measurement results for a set of cells, including each cell's RSRP and RSRQ. The first WTRU may select a cell based on a cell selection criteria. The cell selection criteria may include a group bias offset associated with the cells. The group bias offset for a given cell may be based on the number of WTRUs in the group that are served by that cell.

### CROSS-REFERENCE TO RELATED APPLICATIONS

This application claims the benefit of U.S. Provisional Application No. 63/506,250, filed Jun. 5, 2023, the contents of which are incorporated herein by reference.

### BACKGROUND

When a Wireless Transmit Receive Unit (WTRU) switches on, it may search for a Public Land Mobile Network (PLMN). The PLMN selection is performed at the Non Access Stratum (NAS) layer of the WTRU. Once a PLMN is selected, the WTRU may perform initial cell selection and search for a suitable cell in the selected PLMN. The cell selection is performed by the WTRU Access Stratum (AS) layer. When the WTRU AS layer selects a cell, the WTRU may camp on the selected cell. The WTRU may register its presence by means of a NAS registration procedure.

While in idle mode or inactive mode, the WTRU may perform received signal strength measurements on the selected cell and on neighbor cells. If the WTRU finds a more suitable cell, according to a cell reselection criteria, it may reselect into that cell and camp on it. The WTRU may also regularly search for higher priority PLMNs. If the WTRU NAS layer selects a new PLMN, the WTRU AS layer may search for a suitable cell in the newly selected PLMN and reselect into that cell and camp on it.

While camping on a cell, the WTRU may monitor the control channels of that cell to, e.g., acquire system information and receive paging messages. In order to be found by the network for paging purposes, the WTRU may notify its current location to the network. When reselecting into another cell, the WTRU may perform location update based upon changes on the tracking area or RAN notification area that the new cell belongs to.

### SUMMARY

WTRUs spend most of their time in RRC IDLE/INACTIVE mode states and, accordingly, power consumption associated with IDLE and INACTIVE mode operations may have a strong impact on the WTRU's battery life. Active sensing operations during IDLE and INACTIVE modes, such as scanning the radio channel for PLMN and cell selection and reselection, may be one of the key power drains in these modes of operation. Scanning all the capable frequencies and RATs is also time consuming, which may further impact WTRUs as it may cause delays in performing the PLMN and cell selection and reselection procedures.

Enabling a wide variety of devices and usages, some of the devices (for example, WTRUs and/or personal IoT network (PIN) elements may be limited by the device's capabilities, power, energy, or connectivity to the network. Deploying a system where devices may collaborate and assist each other may improve the devices' performances. In collaborative communications, one device, the “assisting WTRU,” may assist another, the “assisted WTRU,” with its resources, time, or processing power. The devices may coordinate their procedures and communications to enhance each other's performance. In one example, assisted WTRUs may offload some tasks to a more powerful WTRU or share collected information to reduce sensing requirements.

In one case, the WTRUs may be grouped using sidelink connections for their services and applications, and may prefer to keep their main Uu radio off, as much as possible, to save power. If a relay device is present in the group, the WTRU may prefer to communicate to the network via the relay, while keeping their main Uu radio off.

During a cell selection or reselection process, a WTRU in a group of WTRUs may take into consideration information associated with the group, such as the group's serving frequency, serving cell, or the group's frequencies' priorities. Details on the handling of measurements for cell selection and reselection and PLMN selection by a WTRU in group are discussed at length. Criteria for cell selection, cell reselection, and PLMN selection to be used by a WTRU in a group of WTRUs are described in details. Biases are introduced in procedures and criteria based on information associated with the WTRU's group.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented;

FIG. 1B is a system diagram illustrating an example WTRU;

FIG. 1C is a system diagram illustrating the RAN and the CN according to an embodiment;

FIG. 1D is a system diagram illustrating the RAN and the CN according to an embodiment;

FIG. 2 illustrates an example of a measurement model;

FIG. 3 illustrates an example of a network comprising a plurality of personal IoT networks (PINs) and PIN elements;

FIG. 4 illustrates examples of direct communication between WTRUs;

FIG. 5 illustrates examples of roles in a group of WTRUs;

FIG. 6 illustrates an example of a control plane protocol stack with a collaboration layer;

FIG. 7 illustrates an example of a centralized collaboration functionality in WTRUs;

FIG. 8 illustrates an example of a distributed collaboration functionality in WTRUs;

FIG. 9 illustrates an example of a control plane protocol stack for collaboration with WTRUs' AS and NAS layer communication over the PC5 interface;

FIG. 10 illustrates an example of a control plane protocol stack for inter-WTRU assistance where one AS entity may be controlled by multiple NAS entities;

FIG. 11 illustrates an example of a control plane protocol stack for inter-WTRU assistance where one NAS entity may control multiple WTRUs' AS entities;

FIG. 12 illustrates examples of logical interfaces for collaboration;

FIG. 13 illustrates a call flow of an example of network-based coordinator WTRU selection;

FIG. 14 illustrates a call flow of an example of a WTRU-based coordinator WTRU selection;

FIG. 15 illustrates a call flow of an example of a collaborative cell selection procedure for a WTRU with assistance of other WTRUs;

FIG. 16 illustrates a call flow of an example of a collaborative cell selection procedure for a WTRU with a coordinator WTRU;

FIG. 17 illustrates a call flow of an example of a grouped and collaborative cell selection procedure with a coordinator WTRU;

FIG. 18 illustrates a call flow of an example of a collaborative PLMN selection procedure for a WTRU with assistance of other WTRUs;

FIG. 19 illustrates a call flow of an example of a WTRU-initiated collaborative PLMN selection procedure with a coordinator WTRU;

FIG. 20 illustrates a call flow of an example of a grouped and collaborative PLMN selection procedure with a coordinator WTRU;

FIG. 21 illustrates a flow diagram of an example of a method for performing collaborative cell/PLMN selection;

FIG. 22 illustrates an example of a control plane protocol stack implementation for collaboration via the Uu interface;

FIG. 23 illustrates an example of a control plane protocol stack implementation for collaboration via the interface;

FIG. 24 illustrates an embodiment of a collaborative cell selection procedure for a first WTRU;

FIG. 25 illustrates a flow diagram of an example of measurements for cell selection and reselection by a WTRU in a group;

FIG. 26 illustrates a flow diagram of an example of cell selection and reselection criteria used by a WTRU in a group based on biases associated with the group; and FIG. 27 illustrates one embodiment of the solutions described.

### DETAILED DESCRIPTION

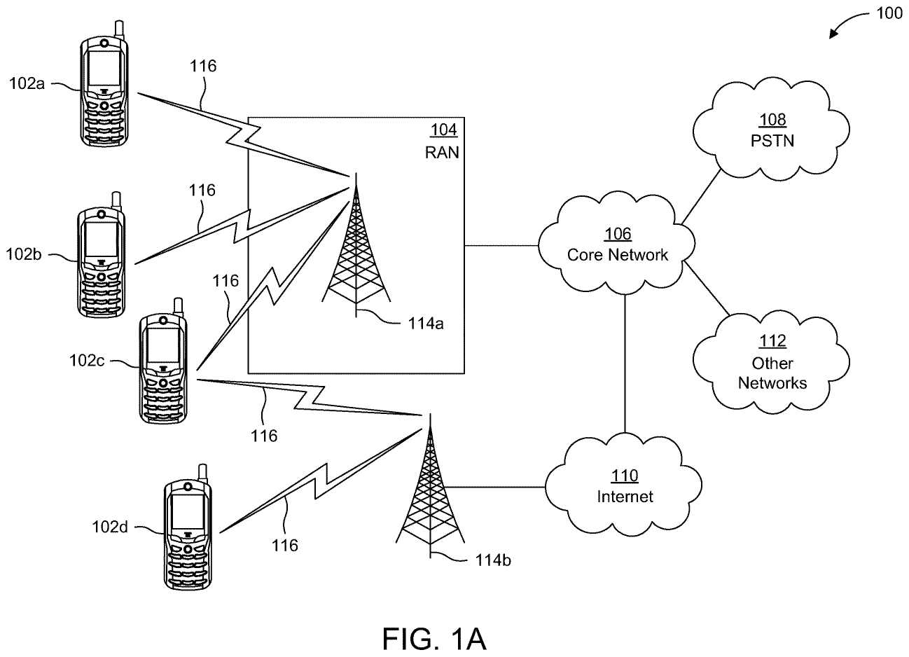

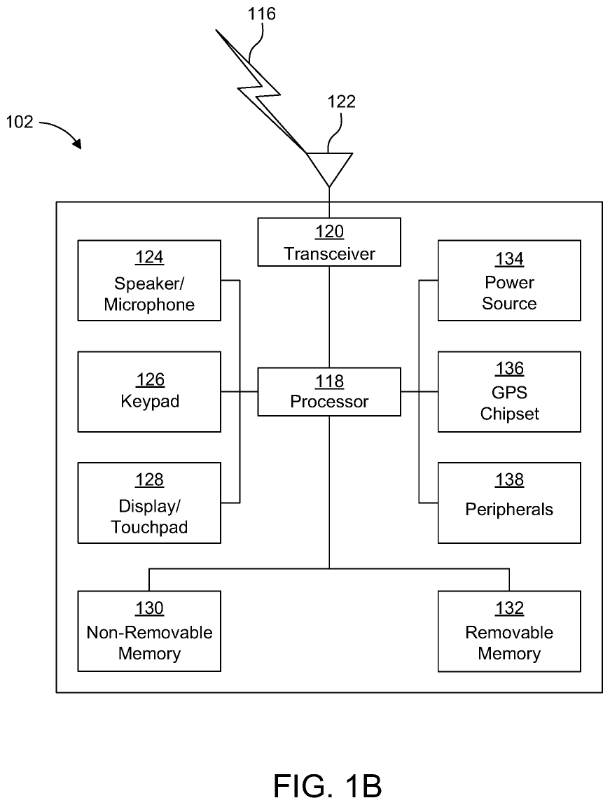

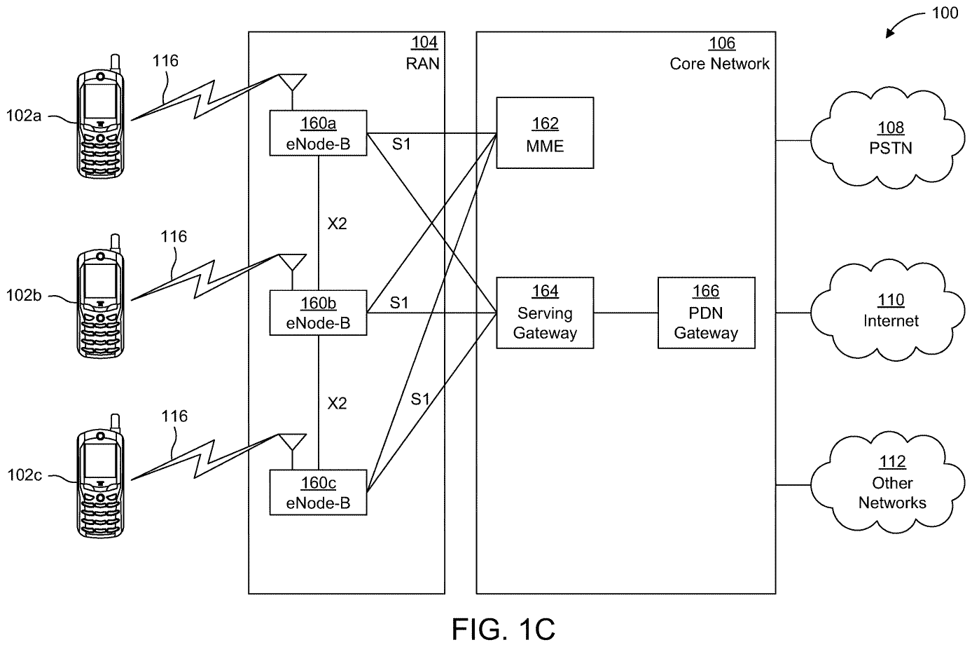

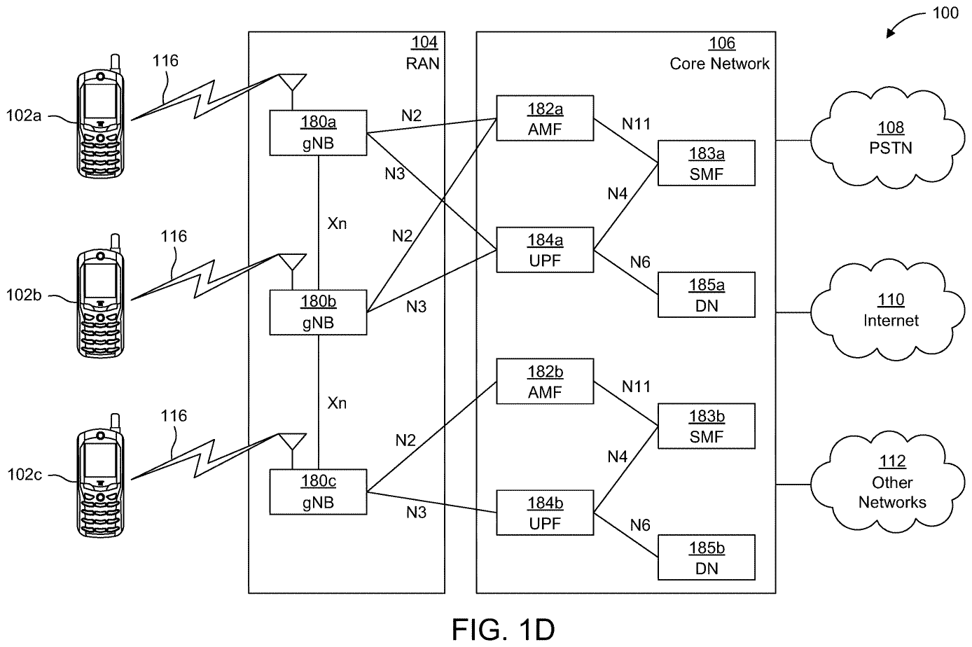

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communications MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### ABBREVIATIONS AND ACRONYMNS

AP Access Point
AS Access Stratum
CA Carrier Aggregation
CAG Closed Access Group
CE Control Element
CN Core Network (e.g., NR or LTE packet core)
CPN Customer Premises Network
DCI Downlink Control Information
DL Downlink
EPC Evolved Packet Core
eRG Evolved Residential Gateway
EHPLMN Equivalent HPLMN
HPLMN Home PLMN
MAC Medium Access Control
MIMO Multiple Input Multiple Output
MTC Machine-Type Communications
NAS Non-Access Stratum
NR New Radio (5G of 3GPP from Rel-15)
NTN Non-Terrestrial Networks
PIN Personal IoT Networks
PINE PIN Element
PLMN Public Land Mobile Network
PRAS Premises Radio Access Station
P2P PINE-to-PINE
P2N PINE-to-Network
PHY Physical Layer
PLMN Public Land Mobile Network
PO Paging Opportunity
RAT Radio Access Technology
RedCap Reduced Capabilities
RF Radio Front-end
RNA RAN-based Notification Area
RRC Radio Resource Control
RSRP Reference Signal Receive Power
RSRQ Reference Signal Receive Quality
RSSI Received Signal Strength Indicator
SCI Sidelink Control Information
SIB System Information Block
SL SideLink
SNPN Stand-alone Non-Public Network
SS Synchronization Signal
U2N User-to-Network
UE User Equipment
UL Uplink
URLLC Ultra Reliable Low Latency Communications
WTRU Wireless Transmit/Receive Unit

WTRUs implementing 3GPP wireless radio access technologies (RAT), including o 2G, 3G, 4G and/or 5G RATs may perform PLMN selection, cell selection/reselection, and location registration including tracking-area update procedures while in RRC_IDLE mode, or RRC_INACTIVE mode. 5G devices may also support RAN Notification Area (RNA) updates and operation in an RRC_INACTIVE state.

When a WTRU is switched on, a PLMN is selected by the WTRU. For the selected PLMN, associated RAT(s) may be set. With cell selection, the WTRU may search for a suitable cell of the selected PLMN, choose the cell to provide available services, and monitor its control channel. The WTRU may register its presence by means of a NAS registration procedure in the tracking area of the chosen cell.

While in RRC_IDLE, a WTRU can perform received-signal-strength measurements on serving and/or neighbor cells. The WTRU may find a more suitable cell according to the cell reselection criteria, it may reselect onto that cell and camp on it. If this new cell does not belong to at least one tracking area to which the WTRU is registered, then the WTRU may initiate a location registration procedure. The WTRU may search for higher-priority PLMNs at regular time intervals. If a different PLMN is selected by the WTRU's NAS layer, the WTRU may search for a suitable cell in the new PLMN.

If a WTRU loses coverage of the registered PLMN, a new PLMN may be selected automatically by the WTRU. Optionally, an indication of available PLMNs may be given to the user via the WTRU so that the user can perform a manual selection. Various means of control exist for the network to prioritize cell selection onto certain RATs, to control the rate at which low-, medium- or high-mobility WTRUs perform cell reselection and to bar selected tracking areas from reselection by WTRUs.

When the WTRU camps on a cell in RRC_IDLE state or in RRC_INACTIVE state, it may receive system information from the PLMN, it may establish an RRC connection or resume a suspended RRC connection, and it may receive Earthquake and Tsunami Warning System (ETWS) or Commercial Mobile Alert System (CMAS) notifications. Moreover, if the network needs to send a control message or deliver data to a registered WTRU, the network “knows,” in most cases, the set of tracking areas where the WTRU is camped. A paging message may be sent for the WTRU on the control channels of all the cells in the corresponding set of tracking areas. The WTRU may receive the paging message and respond.

The WTRU may scan all RF channels in the NR bands according to the WTRU's capabilities to find available PLMNs and available CAGs. On each carrier, the WTRU typically searches for the strongest cell and reads the cell's system information, to find out which PLMN(s) the cell belongs to and any associated Cell Access Groups (CAGs). For operation with shared spectrum channel access, the WTRU may also read the system information of multiple strongest cell(s). If the WTRU can read one or several PLMN identities in the strongest cell, or in multiple strongest cell(s) in case of operation with shared spectrum channel access, each found PLMN may be reported to the NAS as a high quality PLMN (but without the RSRP value) and any associated CAG-ID, provided that the following high-quality criteria is fulfilled: For an NR cell, the measured Reference Signal Receive Power (RSRP) value is greater than or equal to −110 dBm.

Found PLMNs that do not satisfy the high-quality criteria, but for which the WTRU was able to read the PLMN identities, are reported to the NAS together with their corresponding RSRP values and any associated CAG-ID. The quality measure reported by the WTRU to the NAS shall be the same for each PLMN found in one cell.

The search for PLMNs may be stopped on request from the NAS. The WTRU may improve, or even optimize, PLMN search by using stored information, e.g., frequencies and optionally also information on cell parameters from previously received measurement control information elements.

After the WTRU has selected a PLMN, the cell-selection procedure may be performed to select a suitable cell of that PLMN for the WTRU to camp on.

Home PLMN: This is a PLMN where the MCC and MNC of the PLMN identity match the MCC and MNC of the IMSI according to known matching criteria.

EHPLMN: Any of the PLMN entries contained in the Equivalent HPLMN list.

Equivalent HPLMN list: To allow provision for multiple HPLMN codes, PLMN codes that are present within this list replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it is treated as a Visited PLMN for PLMN selection purposes.

Visited PLMN: This is a PLMN different from the HPLMN (if the EHPLMN list is not present or is empty) or different from an EHPLMN (if the EHPLMN list is present).

The WTRU normally operates on its home PLMN (HPLMN) or equivalent home PLMN (EHPLMN). However, a visited PLMN (VPLMN) may be selected, e.g., if the WTRU loses coverage. There are two modes for PLMN selection: In the automatic mode, The WTRU may utilize a list of PLMN/access technology combinations in priority order. The highest priority PLMN/access technology combination which is available and allowable is selected. In the manual mode, the WTRU may indicate to the user which PLMNs are available. Only when the user makes a manual selection does the WTRU try to obtain normal service on the VPLMN.

Cell selection may be initial cell selection (e.g., no prior knowledge of which RF channels are NR frequencies) or cell selection leveraging existing information.

In initial cell selection, the WTRU may scan all RF channels in the NR bands according to the WTRU's capabilities to find a suitable cell. On each frequency, the WTRU may search for the strongest cell (except for operation with shared spectrum channel access where the WTRU may search for the next strongest cell(s)). Once the WTRU finds a suitable cell, this cell may be selected.

In cell selection by leveraging stored information, the WTRU uses stored information on frequencies and, optionally, information on cell parameters from previously received measurement control information elements or from previously detected cells. Once the WTRU finds a suitable cell, the cell may be selected. If no suitable cell is found, the initial cell selection procedure may be started.

The NAS may control the RAT(s) in which the cell selection should be performed, for instance by indicating RAT(s) associated with the selected PLMN, and by maintaining a list of forbidden registration area(s) and a list of equivalent PLMNs.

The WTRU may perform measurements for cell selection and reselection purposes. The WTRU may select a suitable cell based on RRC_IDLE or RRC_INACTIVE state measurements and cell (re)selection criteria.

For cell reselection, to limit the number of measurements the WTRU is required to make, the WTRU first verifies if certain conditions are met. If conditions are met, then the WTRU may start performing measurements in neighbour cells.

When evaluating Srxlev and Squal of non-serving cells for reselection evaluation purposes, the WTRU may use parameters provided by the serving cell. For the final check on cell reselection criteria, the WTRU may use parameters provided by the target cell.

When camped on a cell, the WTRU may regularly search for a better cell according to the cell reselection criteria. If a better cell is found, the WTRU may reselect to that cell. The change of cell may imply a change of RAT.

As an example, the cell selection criterion S may be fulfilled when:
Srxlev>0 and Squal>0, where:
where:

Srxlev is the cell selection RX level value (in dB) and is determined as:
Srxlev=Qrxlevmeas−(Qrxlevmin+Qrxlevminoffset)−Pcompensation-Qoffsettemp; where:
Qrxlevmeas: Cell RX level value (Reference Signal Receive Power, RSRP). Measured by the WTRU.
Qrxlevmin: Minimum required RX level in the cell (dBm). Configured by RRC.
Qrxlevminoffset: Offset used while camped in a VPLMN and searching for a higher priority PLMN. Configured by RRC.
Pcompensation: For FR1: dependent on the WTRU power class, configured by RRC. For FR2=0.
Qoffsettemp: Offset temporarily applied to a cell. Configured by RRC.
Qrxlevminoffset: Offset used while camped in a VPLMN and searching for a higher priority PLMN. Configured by RRC.
Qrxlevminoffsetcell: Cell specific offset, added to the corresponding Qrxlevmin to achieve the required minimum RX level in the concerned cell. Configured by RRC.

Squal is the cell selection quality value (in dB) and is determined as:
Squal=Qqualmeas−(Qqualmin+Qqualminoffset)−Qoffsettemp Qqualmeas: Cell quality value (Reference Signal Receive Quality, RSRQ). Measured by the WTRU.
Qqualmin: Minimum required quality level in the cell (dB). Configured by RRC.
Qqualminoffset: Offset used while camped in a VPLMN and searching for a for higher priority PLMN. Configured by RRC.
Qoffsettemp: Offset temporarily applied to a cell. Configured by RRC.

Absolute priorities of different NR frequencies or inter-RAT frequencies may be provided to the WTRU in the system information, in the RRC Release message, or by inheriting from another RAT at inter-RAT cell (re)selection. In the case of system information, an NR frequency or inter-RAT frequency may be listed without providing a priority (i.e., the field cellReselectionPriority is absent for that frequency).

Different rules may apply to different priorities. In one example, if the serving cell does not fulfil Srxlev>SIntraSearchP and Squal>SIntraSearchQ, the WTRU may perform intra-frequency measurements. In another example, for a NR inter-frequency or inter-RAT frequency with a reselection priority higher than the reselection priority of the current NR frequency, the WTRU may perform measurements of higher-priority NR inter-frequency or inter-RAT frequencies. In another example, for a NR inter-frequency with an equal or lower reselection priority than the reselection priority of the current NR frequency and for inter-RAT frequency with lower reselection priority than the reselection priority of the current NR frequency, in the case where the serving cell does not fulfil Srxlev>SnonIntraSearchP and Squal>SnonIntraSearchQ, the WTRU may perform measurements of NR inter-frequency cells of equal or lower priority, or inter-RAT frequency cells of lower priority.

If threshServingLowQ is broadcast in system information and more than 1 second has elapsed since the WTRU camped on the current serving cell, cell reselection to a cell on a higher-priority NR frequency or inter-RAT frequency than the serving frequency is performed if a cell of a higher priority NR or EUTRAN RAT/frequency fulfils Squal >Thresh_(X, HighQ) during a time interval TreselectionRAT. Otherwise, cell reselection to a cell on a higher priority NR frequency or inter-RAT frequency than the serving frequency is performed if a cell of a higher priority RAT/frequency fulfils Srxlev>Thresh_(X, HighP) during a time interval TreselectionRAT and more than 1 second has elapsed since the WTRU camped on the current serving cell.

Cell reselection to a cell on an equal priority NR frequency is based on ranking for intra-frequency cell reselection.

If threshServingLowQ is broadcast in system information and more than 1 second has elapsed since the WTRU camped on the current serving cell, cell reselection to a cell on a lower-priority NR frequency or inter-RAT frequency than the serving frequency may be performed if the serving cell fulfils Squal<Thresh_(Serving, LowQ) and a cell X of a lower-priority NR or E-UTRAN RAT/frequency fulfils Squal>Thresh_(X, LowQ) during a time interval TreselectionRAT. Otherwise, cell reselection to a cell on a lower-priority NR frequency or inter-RAT frequency than the serving frequency is performed if the serving cell fulfils Srxlev<Thresh_(Serving, LowP) and a cell X of a lower priority RAT/frequency fulfils Srxlev>Thresh_(X, LowP) during a time interval TreselectionRAT; and more than 1 second has elapsed since the WTRU camped on the current serving cell.

Regarding measurements for RRC_IDLE and INACTIVE modes, the WTRU may performs measurement for cell selection and reselection purposes.

When evaluating Srxlev and Squal of non-serving cells for reselection evaluation purposes, the WTRU uses parameters provided by the serving cell. For the final check on cell selection criteria, the WTRU may use parameters provided by the target cell for cell reselection.

The devices, e.g., WTRUs, may measure the Reference Signal Receive Power (RSRP) and Reference Signal Receive Quality (RSRQ) of cells based on the Cell Defining (CD) SSB, i.e., the SS-RSRP and SS-RSRQ.

Synchronization signal (SS) reference signal received power (SS-RSRP) is defined as the linear average over the power contributions (in [W]) of the resource elements that carry secondary synchronization signals.

SS-RSRP may be measured only among the reference signals corresponding to SS/PBCH blocks with the same SS/PBCH block index and the same physical-layer cell identity. If SS-RSRP is not used for L1-RSRP and higher-layers indicate certain SS/PBCH blocks for performing SS-RSRP measurements, then SS-RSRP is measured only from the indicated set of SS/PBCH block(s).

In multi-beam operations, the cell quality may be derived amongst the beams corresponding to the same cell.

Secondary synchronization signal reference signal received quality (SS-RSRQ) is defined as the ratio of NxSS-RSRP/NR carrier Received Signal Strength Indicator (RSSI), where N is the number of resource blocks in the NR carrier RSSI measurement bandwidth. The measurements in the numerator and denominator shall be made over the same set of resource blocks.

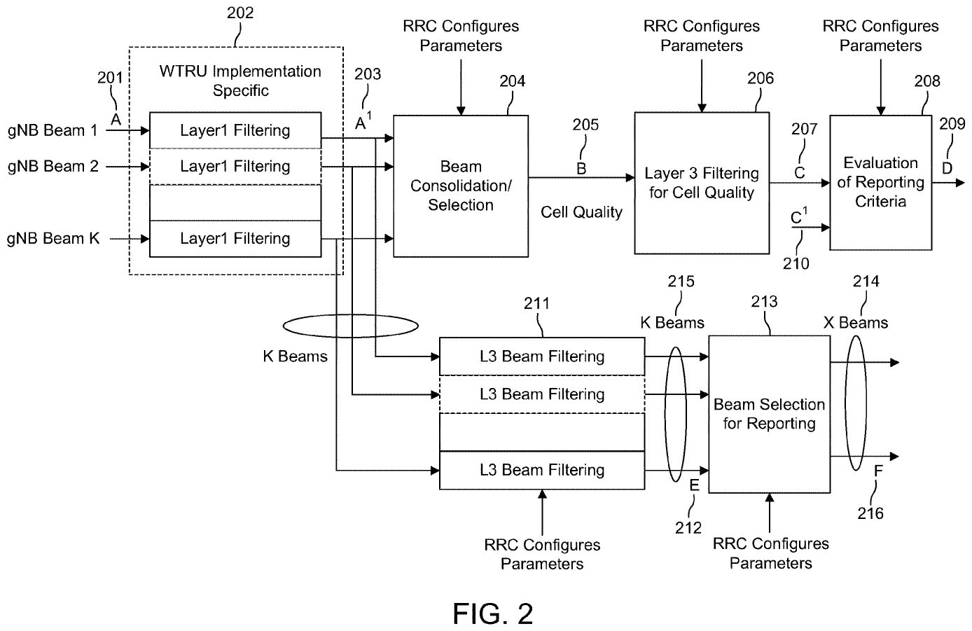

FIG. 2 illustrates an example of a measurement model. As shown in FIG. 2, the beam specific samples (A) may represent the measurements internal to the physical layer 201. The beam specific samples (A) may be the input to a layer 1 filtering 202. Exact filtering may vary depending on implementation choice. The process utilized to perform measurements in the physical may vary (e.g., inputs A and Layer 1 filtering may be implementation specific).

The output of layer 1 filtering, A1 203, may be reported by layer 1 to layer 3 211.

Beam consolidation and selection 204 may be used to consolidate beam specific measurements to derive cell quality 205. The behaviour of the beam consolidation/selection 204 may be standardized, and the configuration of this module may be provided by RRC signalling. The cell quality, B 205, may be derived from beam-specific measurements reported to layer 3 after the beam consolidation/selection 205. The reporting period at B 205 may equal one measurement period at A1 203.

Further layer 3 filtering 206 for cell quality 205 may be performed on the measurements provided at point B 205. The behaviour of the layer 3 filters may be standardized and the configuration of the layer 3 filters may be provided by RRC signalling. The filtering reporting period at C 207 may equal one measurement period at B 205.

The result after a measurement is processed by the layer 3 filter is represented by C in FIG. 2 207. The reporting rate may be identical to the reporting rate at point B 205. This measurement may be used as input for one or more evaluation of reporting criteria 208.

Evaluation of reporting criteria 208 may be the process of verifying whether measurement reporting is necessary at point D 209. The evaluation may be based on more than one flow of measurements at reference point C 207, for example to compare between different measurements. This is illustrated by input C 207 and C1 210. The WTRU may evaluate the reporting criteria at least every time a new measurement result is reported at point C 207, or C1 210. The reporting criteria may be standardized and the configuration may be provided by RRC signalling (e.g., WTRU measurement report configuration).

D 209, as shown in FIG. 2, represents the measurement report information sent on the radio interface (e.g., on a message).

L3 beam filtering 211 may be performed on the measurements provided at point A1 203 (e.g., on the beam specific measurements). The behaviour of the beam filters may be standardized and the configuration of the beam filters may be provided by RRC signalling. Filtering reporting period at E may equal one measurement period at A1.

E 212 represents measurements (e.g., beam-specific measurement) after processing in the L3 beam filter 211. Those measurements are associated with K beams 215. The reporting rate may be identical to the reporting rate at point A1 203.

The beam selection process 213 may result in the selection of X beams 214 out of the K beams 215 measurements provided at point E 212, resulting in the measurement in point F 216. The behaviour of the beam selection may be standardized and the configuration of this module may be provided by RRC signalling.

F 216 represents beam measurement information included in a measurement report (e.g., sent) on the radio interface.

Layer 1 filtering may employ a certain level of measurement averaging. How and when the WTRU exactly performs the required measurements may be implementation specific and may be based on some predetermined performance requirements of the output at B 205. Layer 3 filtering for cell quality 206, and associated parameters, may not introduce any delay in the sample availability between B 205 and C 207, ideally. C1 210 is the input used in the event evaluation for reporting criteria 208. L3 beam filtering 211 and associated parameters may not introduce any delay in the sample availability between E 212 and F 216, ideally.

Measurements are subject to accuracy considerations, where the accuracy requirements are known for the absolute and relative measurements of RSRP and RSRQ, for different scenarios, such as depending on the frequency range, the mode of operation, and/or the temperature.

The use cases described may use various connectivity between the WTRUs, including NR sidelink over licensed bands or unlicensed bands, and WTRUs connecting through the network, including NR Uu. Furthermore, devices such as WTRUs may have multiple radios, where one is dedicated to direct inter-WTRU (e.g., sidelink) and one to the network (Uu). Groups of WTRUs may be formed using sidelink connections between the users while only part of the users of the group may have activate Uu radios.

Personal IoT Networks (PINs) and Customer Premises Networks (CPNs) provide local connectivity between WTRUs and/or non-3GPP devices. The CPN via an eRG, or PIN Elements via a PIN Element with Gateway Capability can provide access to 5G network services for the WTRUs and/or non-3GPP devices on the CPN or PIN. CPNs and PINs have in common that in general they are owned, installed, and/or (at least partially) configured by a customer of a public-network operator.

A Customer Premises Network (CPN) is a network located within specific premises (e.g., a residence, office, and/or shop). The CPN may provide connectivity to the 5G network via an evolved Residential Gateway (eRG). The eRG may be connected to the 5G core network via wireline, wireless, or hybrid access. A Premises Radio Access Station (PRAS) is a base station installed in a CPN. Through the PRAS, WTRUs can get access to the CPN and/or 5G network services. The PRAS may be configured to use licensed, unlicensed, or both frequency bands. Connectivity between the eRG and the WTRU, non-3GPP Device, or PRAS may use any suitable 3GPP or non- 3GPP technology (e.g., Ethernet, optical, WLAN).

A Personal IoT Network (PIN) includes PIN Elements that communicate using PIN Direct Connection or direct network connection and is managed locally (using a PIN Element with Management Capability). A PIN includes at least one PIN Element with gateway capability and at least one PIN Element with management capability. Examples of PINs include networks of wearables and smart-home/smart-office equipment.

PIN Elements may have access to 5G network services via a PIN Element with gateway capability. Using the PIN Element with gateway capability, PIN Elements may be able to communicate with other PIN Elements that may not be within range to use a PIN Direct Connection.

A PIN Element with management capability is a PIN Element that provides a means for an authorized administrator to configure and to manage a PIN.

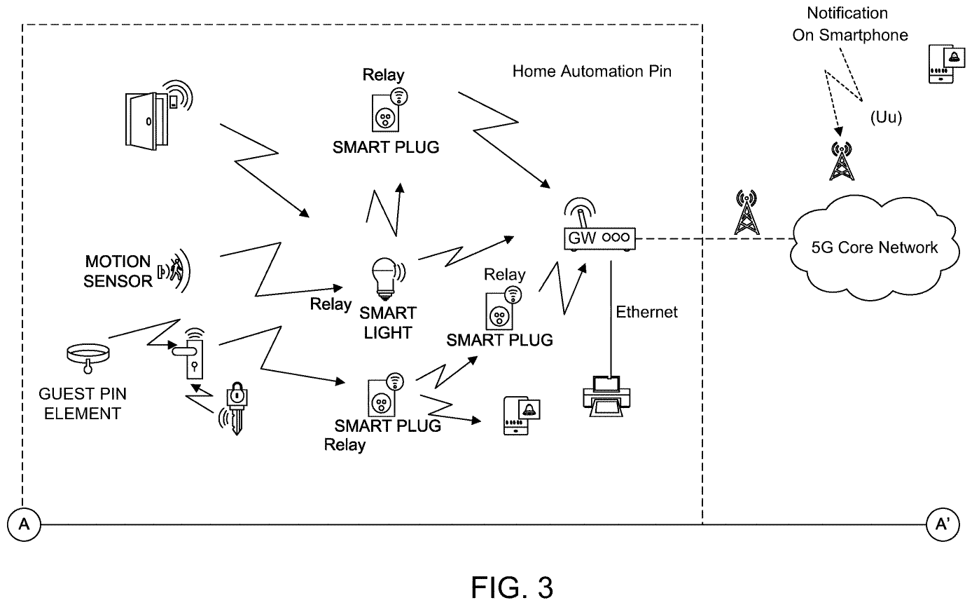

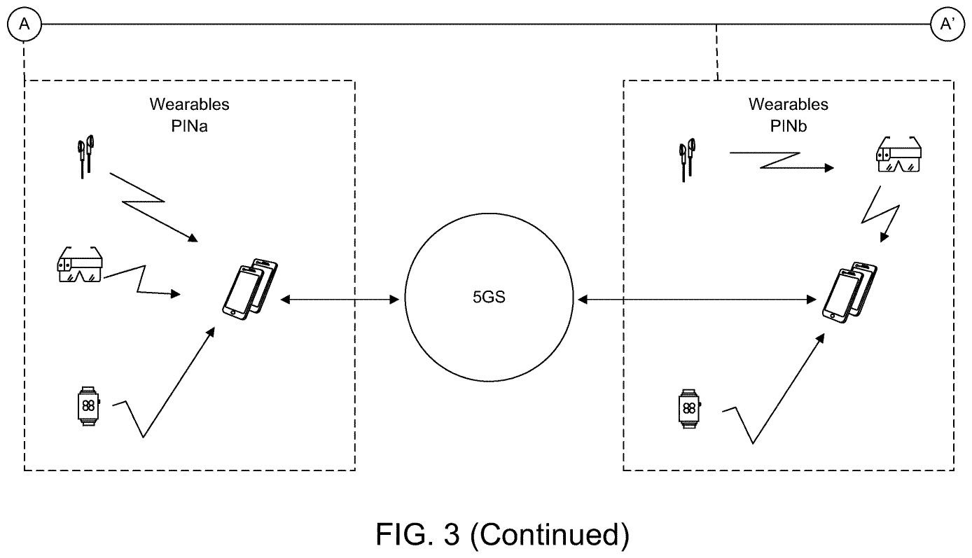

FIG. 3 illustrates an example of a network comprising a plurality of personal IoT networks (PINs) and PIN Elements.

Use cases may include wearable connected objects, such as in the Extended Reality (XR) and/or Augmented Reality (AR)/ Virtual Reality (VR) cases, where the devices may be offloading part of the processing (e.g., audio, video) to a more capable device. The devices may form groups of inter-connected WTRUs that may share their processing capabilities and require communications, typically as wireless communication such as NR sidelink., Industrial network and Industrial IoT (IIoT) use cases may leverage the WTRU collaboration/aggregation framework, where devices such as sensors may be inter-connected, e.g., for redundancy or reliability.

WTRUs may be grouped to assist each other and improve the performance of the devices. Typically, a higher-capable device may assist a lower-capable device to perform some procedures or relay the higher-capable device's signal. Motivations can range from device hardware (small form factor, low-cost device, limited hardware) to energy considerations (low power or low-battery device may reduce its capabilities to save power) or even assistance for coverage and reliability improvements.

WTRU aggregation may refer to a relay solution with specific multi-path properties. This multi-path relay solution may be utilized for WTRU aggregation, where a WTRU is connected to the network via two links: via a direct path and via another WTRU using a proprietary (non-standardized) WTRU-WTRU interconnection. WTRU aggregation aims to provide applications requiring high UL bitrates on 5G terminals, in cases when normal WTRUs are too limited by UL WTRU transmission power to achieve required bitrate, especially at the edge of a cell. Additionally, WTRU aggregation may improve the reliability and stability, and reduce delay of services. If the channel conditions of a terminal are deteriorating, another terminal be used to make up for the traffic performance unsteadiness caused by channel-condition variation.

In an aggregation context, an anchor WTRU is a WTRU that is the source or destination of the traffic and payload data, that may use an aggregated WTRU as a relay. An anchor WTRU may or may not have a direct connection to the network. An aggregated WTRU is a WTRU that assists/helps an anchor WTRU to access the network. In the context of NR sidelink (SL) relay, the anchor WTRU may correspond to a remote WTRU and the aggregated WTRU may correspond to a relay WTRU.

WTRU aggregation may involve a scenario where the WTRU collaboration is expected to enable functionality beyond relaying. WTRUs may aggregate their capabilities (processing, power, time, functionalities) and assist each other performing tasks and procedures.

In the description that follows, the terms “aggregated WTRU” and “assisting WTRU” may be used interchangeably; the terms “anchor WTRU” and “assisted WTRU” may be used interchangeably.

Embodiments that enable procedures, signalling, and configuration for collaboration and aggregation of measurements between WTRUs in RRC IDLE or INACTIVE modes are described, including: enabling collaborative/distributed measurements by offloading parts of the measurements to other devices; processing and evaluation of received measurements for cell and PLMN (re)selection; enabling cell reselection for groups and adapting the priorities and evaluation criteria to regroup WTRUs in the same cell and avoid ping-pong reselection effects.

Group serving cells may refer to the cells that serve WTRUs in the group, or to the cells that serve at least a minimum number of WTRUs in the group, or to the cells that serve at least a minimum percentage of WTRUs group. There may be multiple cells serving the group (e.g., if they are spread in space). Group serving frequencies are the frequencies used in the cells in the group serving cells.

As a high-level view of the embodiments, WTRUs may be configured to assist each other to perform measurements for PLMN selection, cell selection, and cell reselection. The measurements from the WTRU and its assisting/aggregated WTRUs may be used for the evaluation and selection procedures, with specific bias to consider the fact that some measurements are not locally performed.

One case of application of one or more of the embodiments may be the case where WTRUs are equipped with multiple radios, e.g., NR SL+NR Uu, and the sidelink is already used for aggregation/grouping purposes (e.g., application/user needs). In this case the collaboration may be used to avoid turning on the main Uu radio and save WTRU energy.

An assisting WTRU may perform measurements on behalf of an assisted WTRU, so that the assisted WTRU has fewer measurements and less processing to perform and can benefit from the capabilities of the assisting WTRU. The assisted WTRU may offload parts of the frequency scanning required by PLMN and cell (re)selection to other devices. The other devices may scan and return the relevant information to the assisted WTRU, so that it can complete the PLMN and cell (re)selection using the scanning results from other devices (and its own scanning results). Having WTRU collaboration for PLMN and cell (re)selection, the assisted WTRU may not be required to scan all the RATs and frequencies that it is capable of, therefore reducing its power consumption and increasing its battery life. Also, by offloading some scanning to other devices, different scanning may be performed simultaneously, and this may reduce the time needed to complete the scanning, possibly reducing the latency of the overall PLMN and cell (re)selection.

The cell and PLMN selection procedures may be performed when the WTRU is not camping or attached to a cell and it may not have the network configuration. In this scenario, the proposed embodiments may use NR sidelink in unlicensed bands, where the WTRU can perform communications without network configuration or coverage (e.g., using autonomous resource allocation (e.g., mode 2)). NR sidelink using licensed spectrum can be used with network configuration when the measurements are performed for the cell reselection case, or when the collaboration is used for PLMN when searching for a higher-priority PLMN after one is already selected. Cell selection can also be triggered by state transition, e.g., the reception of RRCRelease message, that may contain network information.

In a variation of the embodiments, the inter-WTRU communication may be performed using non-3GPP communications such as Wi-Fi or Bluetooth.

Solutions may be described using examples with aggregation between two WTRUs. The same solutions apply to similar aggregation with more WTRUs.

Regarding architecture and topology for collaboration and aggregation, the WTRU aggregation may be performed using inter-WTRU connection, such as PC5 (sidelink) or any other communication system, standardized or non-standardized, 3GPP or non-3GPP, such as Wi-Fi, Bluetooth, wired connection. Solutions may be described using examples using NR sidelink, but other inter-WTRU interfaces may be used.

The WTRUs may or may not be under the coverage of the network, the connection to the network is not always necessary to perform direct inter-WTRU aggregation.

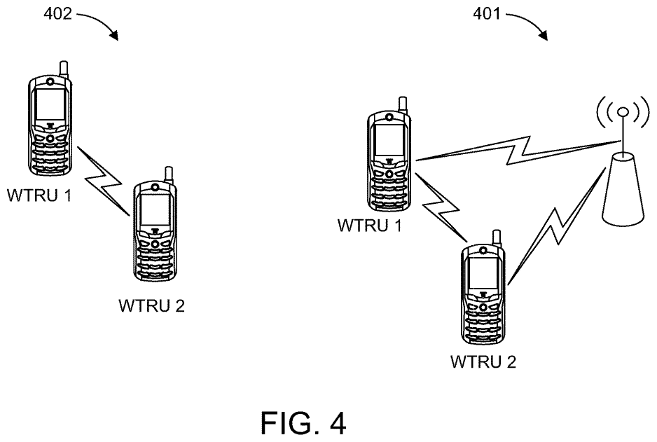

FIG. 4 illustrates examples of direct communication between WTRUs.

As shown, the WTRUs may be within network coverage 401 or outside network coverage 402.

In some cases, such as in Personal IoT Networks (PINs), tethered devices (e.g., XR, wearables), Industrial IoT devices, or interactive services, the devices may need to communicate with each other for the service or application they are interested in. Group of devices may be formed based on the service or application, where the devices may communicate with each other and, in addition, may have a network connection. In the application or service-oriented groups, the WTRUs in the group may be selected and managed by the service/application in a higher layer. The group formation communication exchanges may be configured during the PC5 connection establishment phase, or after the connection is established using for example a newly defined PC5-Collab interface, or leverage the PC5-Signaling (PC5-S) types of signalling, communicating at RRC level (PC5-RRC) with, e.g., RRC messages, MAC level (PC5-MAC) using, e.g., MAC control elements (MAC CE), PHY level (PC5-PHY), using e.g., Sidelink Control Information (SCI).

The groups of WTRUs may either be static (e.g., fixed size and devices in the group) or dynamic, where WTRUs may be added and removed, depending on, for example, the deployment, devices and services.

Depending on the purpose of the group, certain requirements, such as performance requirements, and connectivity between WTRUs in a group may be configured.

For example, one connectivity aspect that may be required is that a group (or a part of a group) be served by the same cell, same gNB, or same PLMN. This requirement may be useful for devices that support multi-path (Uu and SL) but do not support being relayed by a WTRU that is not served by the same cell. This may also be a requirement of the network to facilitate the management and communication with the WTRUS without inter-gNB or roaming exchanges.

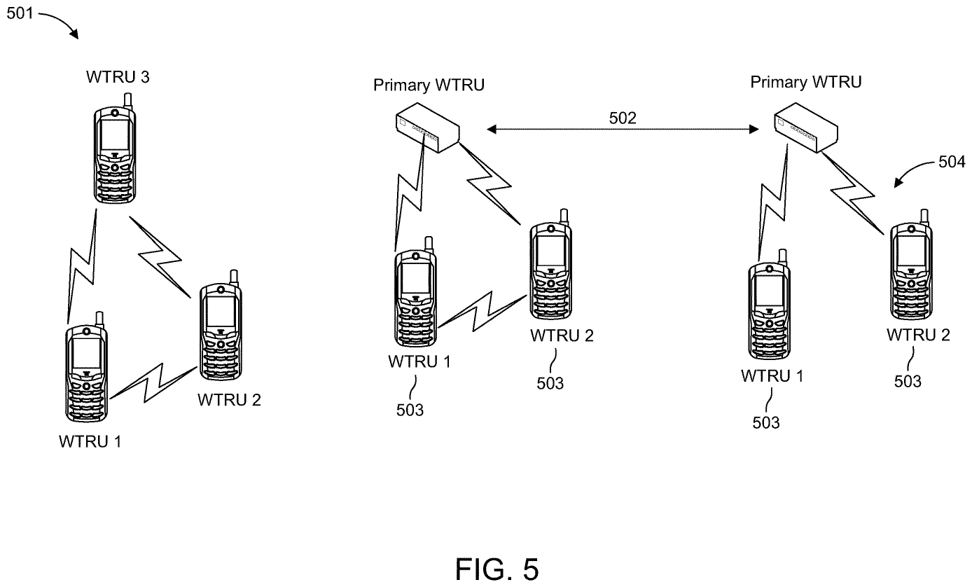

FIG. 5 illustrates examples of roles in a group of WTRUs. In a group, the WTRUs may have different roles depending on the hierarchy between them. In one example, the WTRUs may be viewed as peers in a group 501. In this case, there may be no user managing the others. Collaboration within the group involves sharing information, requesting assistance, or forwarding data or control information to each other.

Another example is to have a primary WTRU 502 connected to other WTRUs 503. The primary WTRU may be a coordinator WTRU 502, which may take the role of a manager, coordinator, or controller for other devices 503.

In the solutions described herein, the primary WTRU may be referred to as a coordinator WTRU.

A coordinator WTRU may be connected to the other devices and may centralize the information distribution among the WTRUs. A coordinator WTRU may centralize the decisions and information in the group and be used to offload tasks or procedures. A coordinator WTRU may facilitate the collaboration among the other WTRUs or of themselves with the other WTRUs. When a coordinator WTRU is present, the direct inter-WTRU collaboration link between two WTRUs performing the collaboration may not be necessary 504.

In a group of WTRUs, one WTRU may take the role of coordinator WTRU. This device takes the responsibility to coordinate the WTRUs of the group to perform tasks jointly or to perform tasks on behalf of the other WTRUs in the group. The coordinator WTRU may also provide the WTRUs of the group with connectivity to the network (e.g., as a relay or gateway). The coordinator WTRU may need to have capabilities to perform the collaboration, including a strong connectivity with the other WTRUs in the group.

The WTRU information shared between WTRUs of a group may be transmitted through the coordinator WTRU, especially when there is no direct connection between the WTRUs performing the collaboration. The information may also be shared via the network (e.g., through Uu interface, e.g., via RRC or higher layer signalling).

The coordinator WTRU may receive the collaboration information from WTRUs and transmit it to the corresponding destinations. The coordinator WTRU may also store the collaboration information to share it with users later, upon request. A WTRUs may request the coordinator WTRU for information that corresponds to a specific WTRU or information associated with the group.

The collaboration between WTRUs requires specific procedures and implementation capabilities. Some devices may implement the necessary features to be a group coordinator, and these features may be represented by a specific WTRU category or WTRU class.

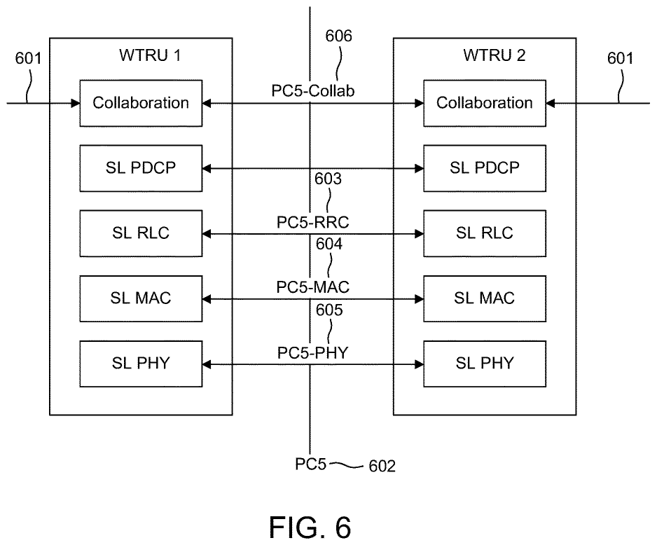

FIG. 6 illustrates an example of a control plane protocol stack with a collaboration layer.

In this example, the collaboration layers 601 of the WTRUs communicate via a direct PC5 communication interface.

The collaboration layer of WTRUs may communicate using the PC5 interface 602. In one example, the collaboration layer may leverage the existing PC5-RRC interface 603 and communicate using, e.g., SL RRC messages. In another example, the collaboration layer may leverage the existing PC5-MAC interface 604 and communicate using, e.g., MAC Control Elements (MAC-CE). In another example, the collaboration layer may leverage the existing PC5-PHY interface 605 and communicate using, e.g., sidelink control information (SCI). In another example, the communication between the collaboration layers may be performed using a newly defined PC5-Collaboration (PC5-Collab) interface 606. The PC5-Collab 606 may be a dedicated interface, optionally with dedicated SRBs to exchange collaboration information.

In the solutions described in the next several paragraphs, the term PC5-Collab or PC5-Collab interface may be used to represent any of such alternative implementations, e.g., PC5-S, PC5-RRC, PC5-MAC, PC5-PHY or a newly defined PC5-Collab interface.

One of the purposes of the collaboration layer is to enable collaboration and communication between layers of protocol stacks, both for Non-Access Stratum (NAS) and Access Stratum (AS) control planes of different WTRUs. Each of the layers perform their own tasks for the connectivity, data transmission and data reception. The collaboration functionality added to the WTRU may serve as an input to be used in the tasks, procedures and decisions made in each of the WTRU's layers.

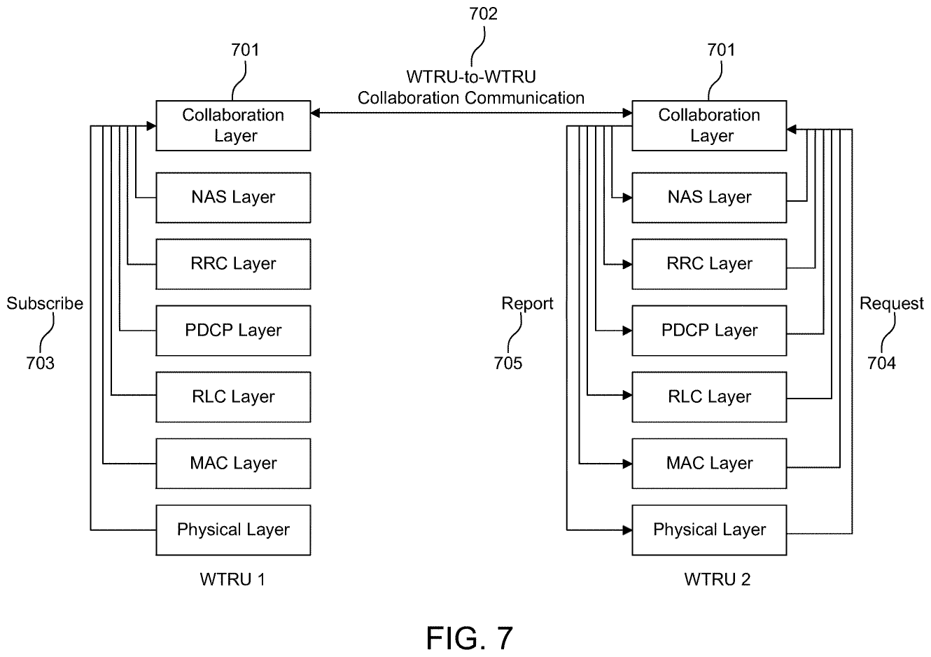

FIG. 7 illustrates an example of a centralized collaboration functionality in WTRUs. In this example, the collaboration functionality may be implemented in a centralized fashion, e.g., with its own collaboration layer in the WTRU 701. The collaboration layers of different WTRUs may communicate with each other 702 and share collaboration information. The collaboration layer may then communicate internally with the other layers of the WTRU to share the information received from the other WTRU. Each layer may be interested in different types of information. In one example, each layer may subscribe to the types of information they are interested in 703. In another example, each layer may request for information 704 from the collaboration layer and, in response, receive a report 705 with the information requested (e.g., information may be provided by the collaboration layer on a demand basis). The request may be for a one-time report or it may trigger periodic or aperiodic reports. Each layer may also report information to the collaboration layer so that the information can be shared with other WTRUs' collaboration layer 701 702. The report may be for a one-time report or it may trigger periodic or aperiodic reports.

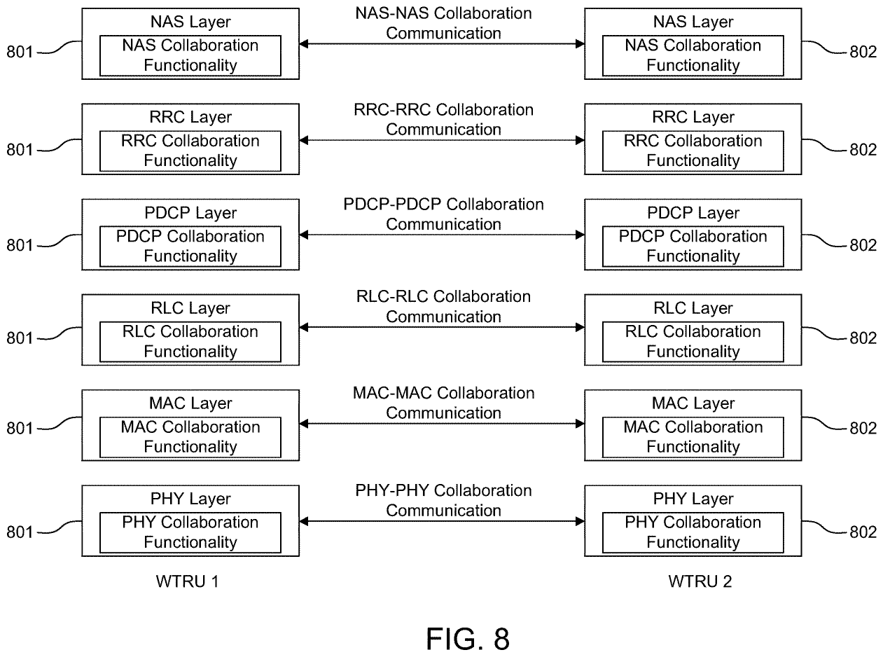

FIG. 8 illustrates an example of a distributed collaboration functionality in WTRUs. In this example, the collaboration functionality is distributed throughout the layers of the WTRU, e.g., PHY, MAC, RLC, PDCP, RRC and NAS layers. Each of the layers of the protocol stack in one WTRU 801 communicates with the peer layers of another WTRU 802, in an independent fashion.

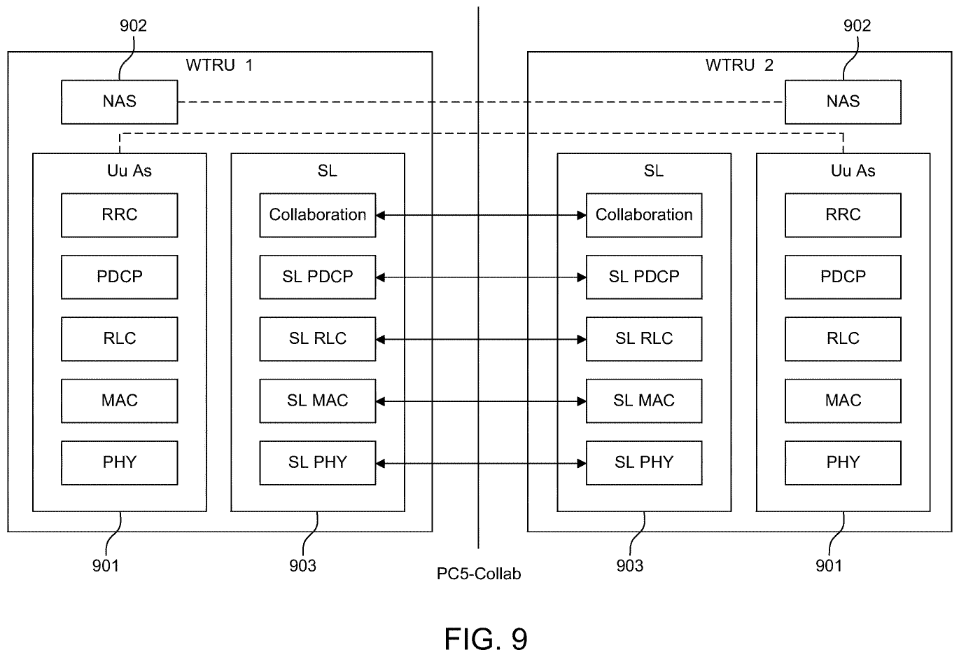

FIG. 9 illustrates an example of a control plane protocol stack for collaboration with WTRUs' AS and NAS layer communication over the PC5 interface.

In this example, using 3GPP architecture and a sidelink for inter-WTRU communication, both the Uu AS 901 and the NAS 902 of WTRUs may be communicating and exchanging messages with each other, via the PC5 interface, optionally over a newly defined PC5-Collab interface 903. At the Uu AS level, the inter-WTRU communication may be performed between any Uu layer, such as PHY, MAC, RLC, PDCP or RRC, directly between the AS layers, or through the collaboration layer 903. For intra-WTRU communication, the collaboration layer may communicate internally with all Uu AS layers, either directly or indirectly (e.g., via AS NAS layer). Optionally, as discussed before, a more distributed approach may be used.

In one example, WTRU1 may offload one or more tasks to WTRU2's Uu AS, or WTRU1 may partition the task in sub-tasks and offload the subtask to WTRU2's AS. The offload decision may be made at the WTRU1 NAS, or WTRU1 AS, or at the WTRU collaboration layer, with inputs from the Uu layers. And although the AS of WTRU2 may be used to perform some tasks on behalf of WTRU1, it may still operate and perform its own procedures (e.g., procedures associated with WTRU2), but in this case it may be commanded by its own NAS for those procedures.

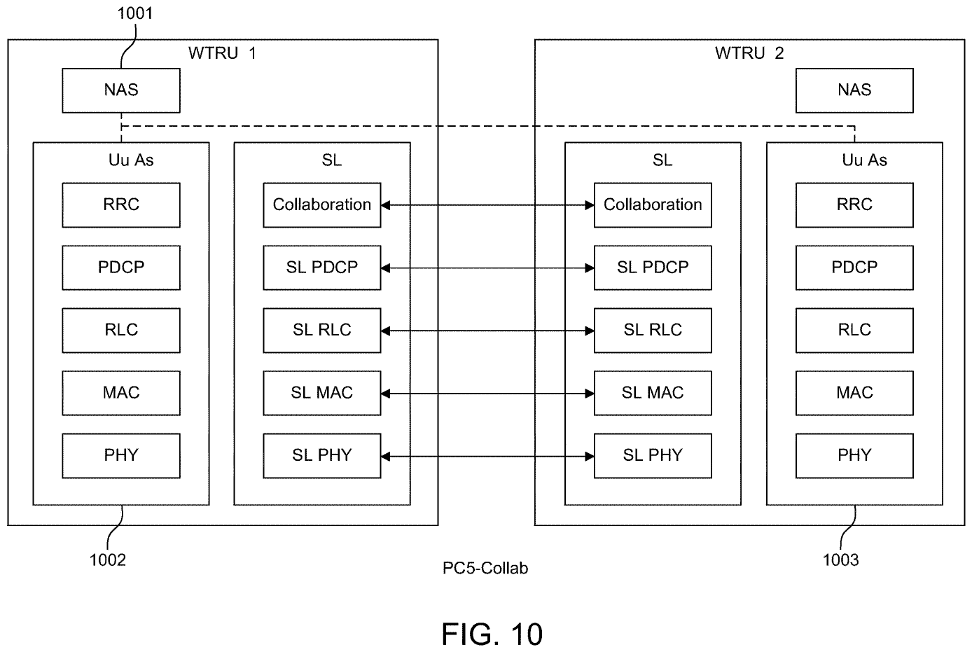

FIG. 10 illustrates an example of a control plane protocol stack for inter-WTRU assistance where one AS entity may be controlled by multiple NAS entities.

In FIG. 10, the example of 3GPP sidelink inter-WTRU connection is used, where the NAS of WTRU 1 1001 may use the Uu AS of two different WTRUs 1002 1003 to perform a task. The NAS layer in WTRU1 1002 may offload a task to WTRU2's Uu AS, or WTRU1 may partition the task in sub-tasks and offload the subtask to WTRU2's AS. The offload decision may be made at the WTRU1 NAS, or WTRU1 AS, or both of them, through a WTRU collaboration layer. The Uu AS of WTRU2 may be still operate and perform its own procedures (e.g., procedures associated with WTRU2) and, for those procedures, in this case it may be commanded by its own NAS.

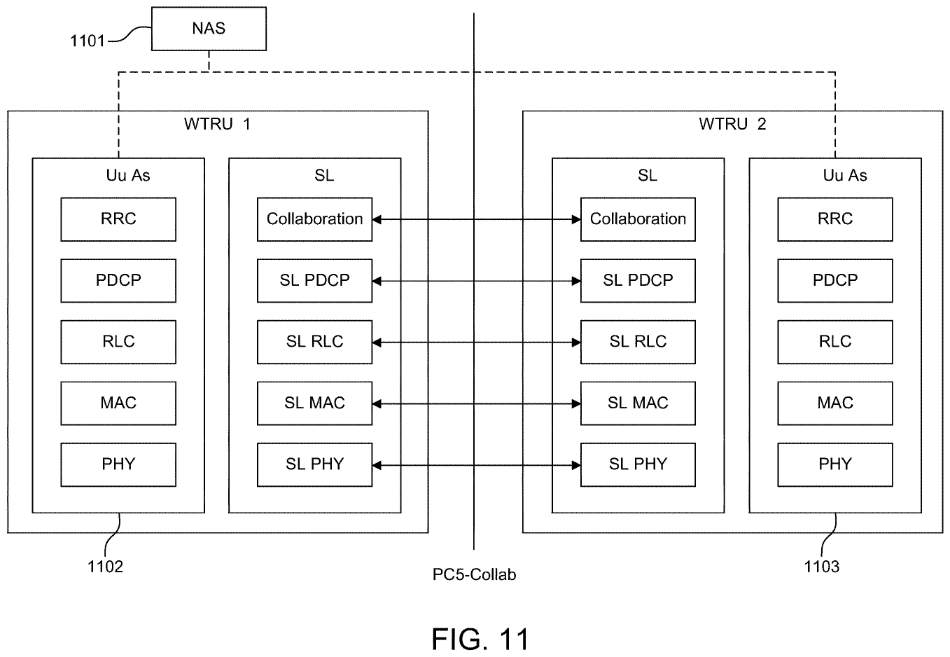

FIG. 11 illustrates an example of a control plane protocol stack for inter-WTRU assistance where one NAS entity may control multiple WTRUs' AS entities.

In this example, a single NAS entity 1101 is directly controlling WTRU1's AS entity 1102 and WTRU2's AS entity 1103. This can be extended to multiple WTRUS, as two WTRUs are used as an example for illustrations purposes. The NAS entity may be located within one of the controlled WTRU or in another WTRU. The communication between the NAS and AS layers that are not collocated is performed using inter-WTRU collaboration, e.g., PC5-Collab interface or other inter-WTRU interfaces.

Prior to performing collaborative procedures, the WTRUs may exchange information for configuration (e.g., to configure how they coordinate), information on their capabilities and their communication channels.

The collaboration configuration may include information such as available RATs; supported bands/carriers; interface capabilities (e.g., Uu and SL capabilities); WTRU profile (WTRU type, power profile); WTRU collaboration capabilities (e.g., which procedures are supported to be coordinated, which information requests or sharing are supported).

A WTRU may send direct transmissions to the users in its group using PC5, including unicast, groupcast or broadcast transmissions. The transmissions may be event basis, periodic, or aperiodic. The frequency may depend on the content of the transmission.

The collaboration configuration may include the scheduling or occasions when the WTRU is expected to transmit or receive collaboration signalling (e.g., using periodic or dynamic scheduling).

A WTRU may request information from another WTRU. The WTRU may send a request over the PC5-Collab interface and receive a reply/report, also on the PC5-Collab interface, at the layer corresponding to the collaboration. In an example, the request may be a Layer 1 measurement of reference signals, exchanged between the PHY layers of the WTRUs; or an L3 measurement of reference signals, exchanged between the RRC layers of the WTRUs. It may also be at the MAC layer level, e.g., using MAC CE.

The request may be for a one-time report or may be triggering periodic/aperiodic reports (i.e., subscribing to a collaboration content). When a WTRU receives a request, it may reply with the information to report if available (and possibly after performing some related procedures). The WTRU may report to the WTRU that transmitted the request. When WTRUs are registered for specific periodic collaboration, a WTRU may periodically or be triggered by an information update report to the requesting/registered WTRUs.

In complement to the previous architecture, one WTRU may also request the other WTRU to perform selected tasks on its behalf.

In one example, the cooperating WTRUs may first coordinate their NAS and AS configurations, e.g., available RATs, supported frequency and procedures.

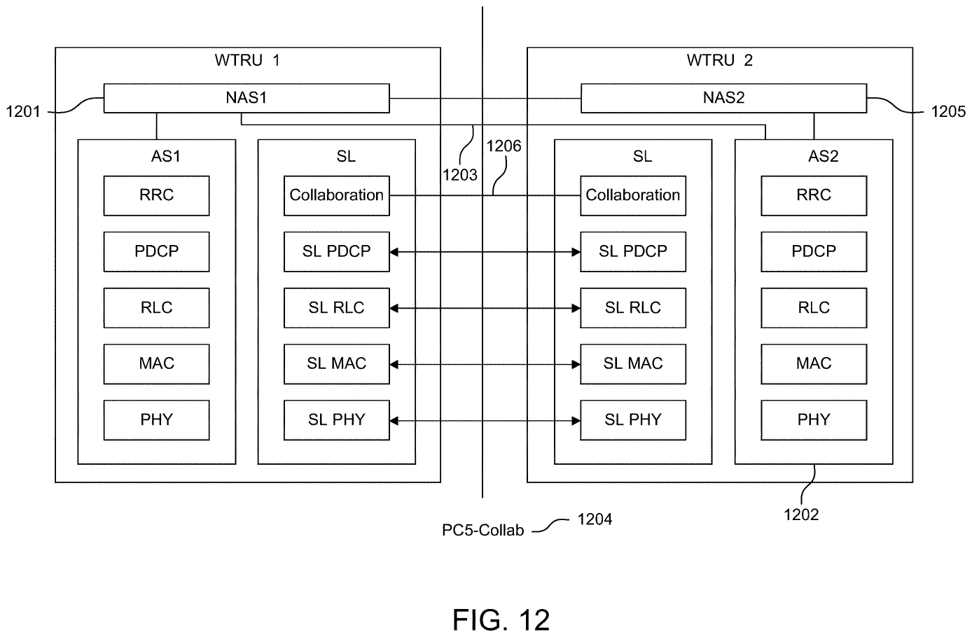

FIG. 12 illustrates examples of logical interfaces for collaboration.

In terms of logical functionality, the NAS of WTRU1 (NAS1) may communicate via an interface with the AS of WTRU2 (AS2). To execute this communication, the PC5 interface is used: NAS1 1201 may send a command to AS2 1202 using the logical interface NAS1-AS2 1203, via PC5-Collab 1204. WTRU2 may then perform the procedure or task requested and, after completing the procedure or task, WTRU2 may report the output to NAS1 using the logical interface NAS1-AS2 1203, via PC5-Collab 1204. The content of the reports and commands may be kept similar to the typical inter-layer communication within a single WTRU, but where the interfaces may be changed (e.g., the destinations may be changed to the upper-layer (or lower-layer) of another WTRU) and the information is encapsulated to be sent to the peer WTRU.

In an alternative implementation, NAS1 1201 may perform tasks using AS2 1202, but via the NAS layer of WTRU2 (NAS2) 1205. NAS1 1201 may send a request for offloading to NAS2 1205, and NAS2 1205 may send the task request to AS2 1202 (e.g., either transparently or controlling AS2 behaviour for compatibility and collaboration with the rest of the WTRU's task).

Optionally, a collaboration layer may be leveraged to send tasks requests and reports between the WTRUS.

Regarding WTRU information exchange for collaboration/aggregation, to perform collaboration between the WTRUs of a group, some information can be shared so that WTRUs know about each other's capabilities and status. This information can be used for group collaboration management, such as coordinator selection, task distribution or report sharing. Such information may be:

WTRU capabilities such as frequency band support, RAT support, antenna/beam support, measurement capabilities etc. i.e., any information related to how the device can perform the measurement on the SSBs and cell search.

WTRU category, e.g., if the WTRU is a special kind of WTRU (e.g., non-terrestrial network (NTN), reduced capability (RedCap), ultra-reliability and low-latency communications (URLLC), Coordinator).

WTRU stored information. This indicates what the WTRU already found previously and may quickly find upon performing the stored information-based cell selection.

WTRU battery/energy status. This indicates whether the device needs to preserve its energy and should be avoided to perform tasks. E.g., power saving mode activated or not, power profile, remaining battery level.

WTRU location: spatial information (e.g., absolute, or relative position, direction, speed) can be useful to determine the proximity between devices and so the redundancy of their measurements.

WTRU inter-connection in the group: inter-connected WTRU can easily share information directly and can update each other. Capabilities of the inter-connection such as the PC5 radio-interface, radio conditions, PC5 resource availability, etc.

WTRU collaboration capabilities, e.g., capabilities to supported being in a group, or being a coordinator, or which features, and procedures are supported to be distributed or offloaded.

WTRU service type and QOS requirements, e.g., what type of service is needed to be supported in the group for this user and what kind of requirement the WTRU expects to be assisted with for this group.

WTRU connection to the network status (in or out of coverage, RRC mode, Cell/PLMN ID etc., if any).

The information can be shared between the users, directly or via a coordinator, using PC5-Collab interface, between the AS (e.g., at the RRC level) or at the NAS level depending on the collaborative procedures. This can be exchanged during or after the PC5 link establishment between the devices, when exchanging configuration or capabilities about devices. Some information may further be shared between the users, periodically or on-demand, to keep updated the devices in the group, e.g., the battery status, location.

For determination of the primary/coordinator user in a group of WTRUs, one WTRU may take the role of coordinator (or manager, or primary) WTRU. This device may take the responsibility to coordinate the WTRUs of the group to perform tasks jointly or to perform tasks on behalf of the other WTRUs in the group. The coordinator WTRU may need to have the capabilities to perform the collaboration as well as a strong connectivity with the WTRUs in the group.

The coordinator WTRU may also provide the WTRUs of the group with connectivity to the network (e.g., as a relay or gateway).

Procedures to select the group coordinator are described.

In one example, some devices may be specialized for WTRU collaboration and be provisioned or hard-coded or (pre)configured to be coordinator WTRUs. When included in a group or when connecting with other WTRUs, these devices may be automatically selected to be the coordinator. Such a WTRU may announce its capability and role upon connection establishment in the SL, during capability exchange, for example.

This type of WTRU may, for example, be placed in selected locations where some specific service requirements are hard to achieve with regular uncollaborative WTRUs, e.g., for a dense WTRU scenario and/or assisting the WTRUs and network to provide the service and QoS required.

In one example, when a group of users is being configured in a collaboration communication group, the assisting WTRU may become the coordinator/primary WTRU, while the assisted WTRU(s) may be the secondary WTRU(s).

In another example, the service or application for this group may be configured by the application layer that designates the device to be a coordinator, e.g., the device that initiates the service or a more capable device. The configuration of the group may include the coordinator configuration and is shared between the users.

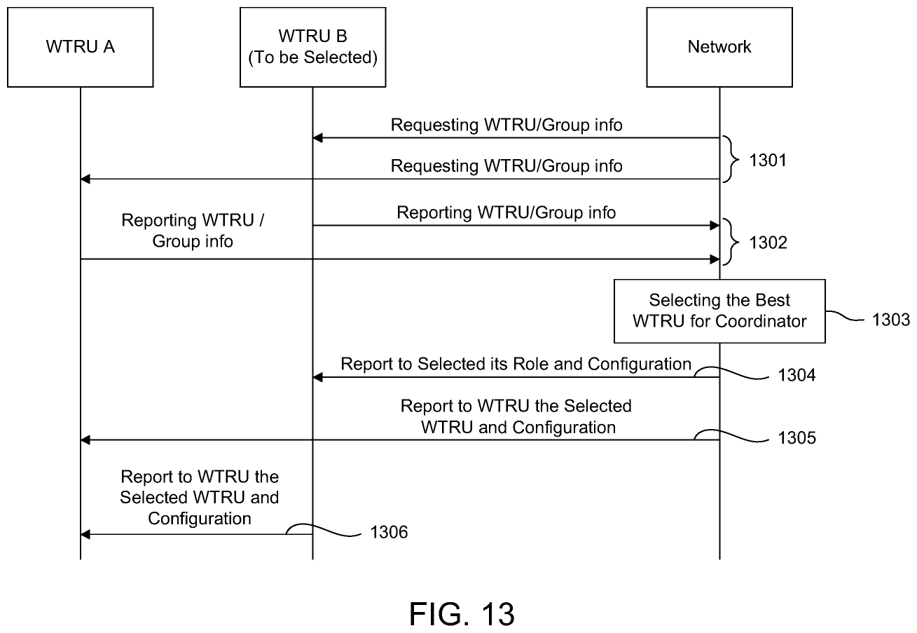

FIG. 13 illustrates a call flow of an example of network-based coordinator WTRU selection

In another example, the network performs the selection of the coordinator WTRU for the group. Note that the WTRUs may communicate with the network directly (e.g., via Uu RRC, DCI, or paging messages for IDLE/INACTIVE UEs) or through relays.

Referring to FIG. 13, the network may request information or updates on the group and WTRUs in the group 1301. The WTRUs in the group may report their information to the network 1302.

Various information may be used to select the coordinator WTRU. In particular, the WTRU capability to perform the collaboration tasks, Uu capabilities, SL capabilities, Uu link quality (e.g., Uu RSRP), SL connection status and SL RSRP to other devices in the group, number of hops to other devices, Service associated with the group and its QoS, Cell ID of the WTRUs. connection states, or PLMN ID.

Information pieces about WTRU configuration and setup may be exchanged during connection setup or through RRC. Dynamic information such as RSRPs or connectivity status may be obtained from reports such as WTRU CSI reports or based on the request by the network.

The network selects the coordinator WTRU based on reported WTRU information 1303.

The selection may be based on the WTRU capability of supporting inter-WTRU collaboration.

WTRUs may be ranked according to a score that is computed for each WTRU. The score/priority may be based on the WTRU information criteria that may be computed directly by the network, or by WTRUS, autonomously. The WTRU with the highest rank/score/priority may be selected to be the coordinator. The scores may be shared by the network or between the WTRUs to find the highest score WTRU.

In an example, the score is based on the WTRU with the strongest Uu RSRP to be the coordinator WTRU, to ensure reliable communication between the network and the coordinator.

In another example, the score may be based on maximizing the link quality and minimizing the number of hops between the users can be a criterion, to maximize the reliability and minimize delay between the WTRUS.

In another example, the score may be based on the energy status of the WTRU, where low-energy devices may be avoided.

In another example, the score may be based on the number of WTRUs that are served by the same cell or same PLMN.

In another example, the score may be based on the geographical location (absolute or relative) or speed of the devices.

The network may send an indication to the selected WTRU informing about its coordinator role 1304. The network may assign collaboration tasks and configuration to the coordinator.

The network may also indicate the coordinator WTRU to the other WTRUs of the group 1305. Alternatively, or in complement the coordinator WTRU may indicate its status to the WTRUs in the group 1306, via inter-WTRU communication, e.g., using the PC5-Collab interface.

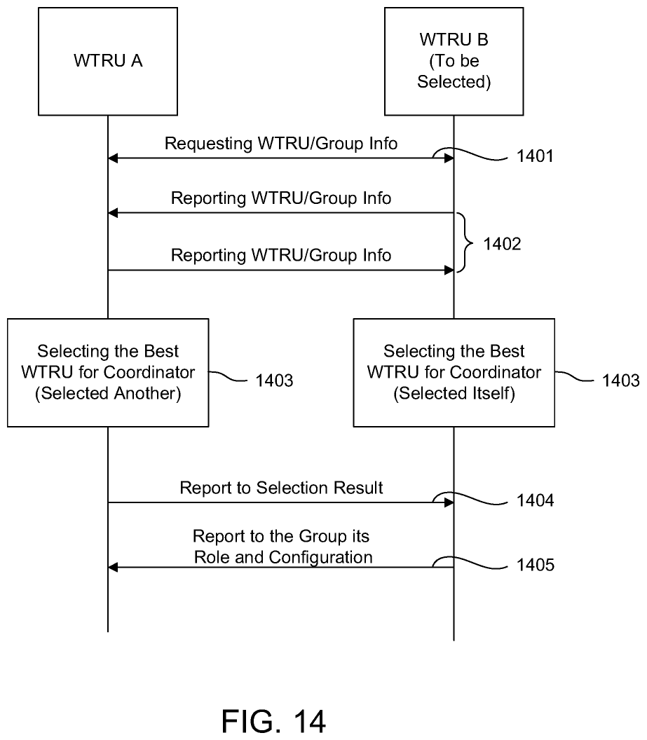

FIG. 14 illustrates a call flow of an example of a WTRU-based coordinator WTRU selection.

In this example, the coordinator WTRU is selected between the WTRUs autonomously. The communication between the WTRUs can take place for example over PC5-Collab, e.g., at the RRC level.

A WTRU, WTRU B, may request WTRU information or an update on WTRU information to the WTRUs in the group 1401. The WTRUs in the group report their information to the network. Similar information may also be exchanged between the WTRUs 1402 and between WTRUs and network in previous option.

Some aspects of the WTRU information may be exchanged during WTRU direct communication setup or grouping setup, such as the capabilities; or may be exchanged more dynamically, such as link conditions.

In parallel, WTRUs select the coordinator WTRU based on reported WTRU information 1403. Similar rank as previously described may also be used here.

The WTRUs may share the results with each other, indicating the selected WTRUs and/or ranking results 1404. The selected WTRU (step 4b) may further indicate itself as the coordinator, with additional collaboration configuration 1405.

When establishing the ranking of the potential coordinators, WTRUs may base their computation on the same information input from other users, which may result in the same ranking. However, if the information shared is not correctly synchronized (e.g., data loss, lack of connectivity, outdated information) the results may be different and multiple WTRUs may be selected for coordinators. In this case, and if the group is configured to only support a single coordinator, the selected coordinators may exchange their information with each other and perform a limited ranking comparison to down-select the final coordinator. The result of this converging selection is shared with the WTRUs in the group (similar to 1404).

Although embodiments of solutions focus on selecting one coordinator for a group, it is also possible for a group to have multiple coordinators. Different coordinators in a group may handle different managing tasks, or handle subsets of the WTRUs in the group. One example is in the case of a group of WTRUs for a service or application where the WTRUs belong to different operators or are not in proximity and associated with different cells, and there may be one coordinator defined, e.g., per PLMN, per cell, or based on geographic proximity.

### Collaboration for Measurements and Cell Selection and Reselection

Regarding collaboration via delegating measurements and/or collaborative cell selection with inter-WTRU collaboration, where the cell selection task is distributed across multiple WTRUs, is described.

After selecting a PLMN (or SNPN), the NAS may provide a list of equivalent PLMNs, if available, that the AS may use for cell selection and cell reselection. With cell selection, the WTRU may search for the strongest suitable cell of the selected PLMN or selected SNPN, and choose that cell to provide available services and monitor its control channel, i.e., the WTRU may search for a cell to camp on.

Collaborative cell selection may use multiple devices of the group to distribute/offload part of the cell selection and channel scanning procedure. This way, different devices of the group may be responsible for a part of the scanning effort. This may parallelize and speed up the process, as well as save energy and processing in the devices.

The collaborative/collaborative cell selection may be done for the group, i.e., the whole group may select and camp on a cell; or a group may mutualize its resources to find a suitable cell for a given user (i.e., the WTRU offloads part of its cell search to other devices).

The following describes examples of the collaborative cell selection between two devices, this can be extended to multiple collaborative devices, and the receiving device may regroup/aggregate the multiple received reports in a similar way as presented.

The following describes examples of the collaborative cell selection procedure, a similar procedure can apply also for the cell reselection procedure (specific aspects related to the cell reselection procedure as part of a collaboration group are described below).

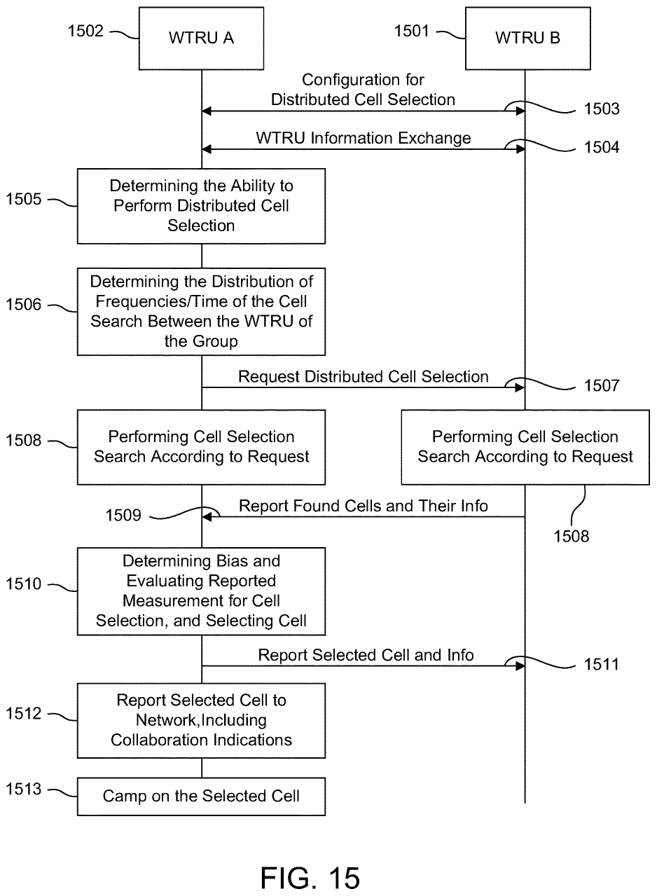

FIG. 15 illustrates a call flow of an example of a collaborative cell selection procedure for a WTRU with assistance of other WTRUs.

In this example, cell selection is intended to be performed by a WTRU with assistance of one or more WTRUs. WTRU B 1501 is the assisting WTRU and may scan the cells and select the best cell for the assisted WTRU, which is WTRU A 1502. The examples use a single WTRU to assist, but may be generalized for the case of multiple assisting WTRUs. In one example, the procedure may be repeated for each WTRUs.

In this procedure, the inter-WTRU signalling may be carried through SL, or through any established communication interface between the WTRUs such as Wi-Fi or Bluetooth. In the case of SL interface, the cell selection may be a step performed before receiving the network configuration. The WTRUs may be required to use SL over unlicensed bands, typically using the Mode 2 resource allocation scheme. When using unlicensed bands, the communication between the WTRUs may experience delays or blockage due to collisions and retransmissions. In an embodiment, however, the timing is not necessarily a very sensitive aspect, and the procedure may resume after successful transmissions.

As per FIG. 15, a group of WTRUs may exchange signalling to enable and configure the collaborative cell selection 1503. The WTRUs in the group may share the configuration information that may enable the collaborative cell selection for WTRUs 1504. The configuration may be pre-provisioned in the WTRUs, pre-configured in the WTRUs, configured by the network, or exchanged using dedicated signalling between the WTRUs, or a combination thereof.

The configuration may include the triggers and conditions to request the collaborative cell selection. For instance, a WTRU may request collaborative cell selection when its battery level is low; or when the WTRU is in the cell edge, or when the WTRU failed to select a suitable cell in a previous attempt; or when the WTRU changes its collaboration group (e.g., a new assisting WTRU).

The configuration may include a report content and criteria to select cells for reporting. Specific criteria may be provided, such that the cells to be reported may include the set of cells measured that satisfy the specific criteria.

The typical cell selection criteria generally known in the art (e.g., criteria S) may be used directly.

In one example, the sub-criteria Srxlev (RX level) and Squal (cell selection quality) may be altered by e.g., adding an offset that may be configured in system information broadcast, or by being overridden by dedicated signalling, or by applying a dedicated offset. These sub-criteria may be relaxed so that the WTRU performing the scanning may report more cells (cells that the requesting WTRU may find with better quality) or the sub-criteria may be tightened, so that the WTRU report may include only cells with strong signal, e.g. if the measuring WTRU is expected to be used as an assisting WTRU jointly with the requesting WTRU.

In another example, cells that are considered as barred for the measuring WTRU may be excluded from the reporting list, if the measuring WTRU is acting as an assisting WTRU for the requesting WTRU after the cell selection procedure. Even though the cell is barred for the assisting WTRU, if the assisting is only assisting the assisted WTRU, the assisting WTRU may report that cell to the assisted WTRU (for assistance on cell selection purposes only).

In another example, if the assistant WTRU also needs to connect to that cell (e.g., for other assisting tasks after the cell selection), the assistant WTRU may not be able to report that cell because that cell is barred.

In another option, cells that are considered as barred for the requesting WTRU may be excluded from the reporting list.

The reports may be configured to include the cell ID, barring/reservation info, corresponding PLMN, corresponding frequency and channels, RSRP, RSRQ or RSSI values, SSB info, time and location of the measurement.

The configuration may include the timing for the procedure requests and reply. For instance, the requests may be transmitted on selected resources or occasions, to be monitored by the WTRUs in the group configured and supporting collaborative cell selection. The scanning reports may also be configured to be transmitted on selected resources or occasions and can also be configured with a maximum timing requirement to send their report after the reception of a request.

The configuration may include the computing method and parameter/offset values used for the collaborative cell selection criteria to be used by the WTRU to select a cell from the collaborative cell selection procedure 1503.

WTRUs exchange their information and status, based on collaborative cell selection configuration 1504.

The WTRUs may exchange their information, e.g., per above, during the WTRU-to-WTRU individual connection configuration, group or collaboration configuration or on dedicated messages. Some of the information may be updated periodically or based on a change of status triggers, such as battery status, connectivity updates, location updates. Thus, note that step 1 and step 2 are not necessarily in this order and step 2 could be split into multiple exchanges.

WTRU A checks whether it is configured and enabled to perform a collaborative cell selection 1505.

The collaborative cell selection may be initiated based on selected triggers that may be configured between the WTRUs and/or the network.

For example, WTRU A may request collaborative cell selection when its battery level is below a configured threshold; or when the WTRU is at the cell edge, or failed to select a suitable cell in a previous attempt, or when there is a change in the WTRU collaboration group (e.g. a new assisting WTRU), or after a (collaborative) PLMN selection, or after turning on the main radio receiver, etc.

WTRU A may determine which WTRUs may assist it and how the cell selection scanning task may be distributed between the WTRUs, based on the received configuration and WTRU information 1506.

In one embodiment, the determination how to distribute the cell selection scanning task may be based on the available RATs of the devices, where for example, different devices are configured to monitor different RATs, thus avoiding all the RATs to be turned on all the devices.

In another embodiment, the determination may be based on the frequency capability of the devices, to assign users to (part of) their capable frequency and channels. The cell selection frequency sharing may be with or without overlap between the WTRUs of the group (or between parts of the WTRUs of the group). Partially overlapping frequency scanning may provide more diversity in scanning from different devices at the cost of increasing the workload.

In another embodiment, the distribution may be performed according to the location of the devices (absolute or relative locations). Proximity with the requesting WTRU may be a criterion for the selection devices to distribute the cell scanning, e.g., the devices can be either with a maximum distance or even be required to be collocated. In another aspect, the relative distance of two other devices may also be a criterion, e.g., not selecting two very close other devices to scan the same parts of the spectrum as they will likely be redundant.

In another embodiment, the processing capabilities, power profile and battery level (e.g., if a device is using power saving mode, or having a battery below a threshold level) of the users may be considered to prioritize the amount of processing/monitoring to perform between the users.

In another embodiment, the connectivity between the requesting WTRU and the other WTRUs (interface type, number of hops) may be a criterion to prioritize distributing the scanning task to WTRUs with low-latency/reliable connection to the requesting WTRU.

In another embodiment, the distribution of scanning among the devices may also be performed in the time domain, where some devices are required to perform some scanning task at given times, e.g., with some on/off patterns, or for specifically selected timings only. This way the devices may distribute the active time between devices and thus reduce the power consumption.

In another embodiment, the distribution of scanning among the devices may also be dependent on the beamforming capabilities of the devices, and the WTRUs may distribute the beams or directions to be scanned. For instance, if a two WTRUs in proximity or collocated have beamforming capability, one WTRU may scan using a part of the beams, while the other WTRU may scan using the other part of the beams.

The assisted WTRU may determine the other WTRUs that will assist it, and also a priority for these WTRUs based on above criteria, such as the WTRU role (coordinator, relay), capability or location. The priority may further be used when conflicting measurements are to be reported.

WTRU A may transmit a collaborative cell selection request to WTRU B, according to the configuration and including the scanning requirements 1507.

The request may include the RATs, carriers, and channels to be scanned by the devices, as determined in step 4.

The request may include the selected PLMN by WTRU A and may also include the equivalent PLMN.

The request may include the timing information, if any, for the device to scan the indicated spectrum.

The request may include the beamforming information, if any, for the device to scan the indicated spectrum.

The request may indicate the maximum time or the occasions for the report to be transmitted.

WTRUs perform the cell scanning task on their requested carriers and channels, time and beamforming, if any 1508.

When scanning for a cell over a dedicated spectrum, the WTRU may only look for the strongest cell and if suitable, it may select it to be camped on. In the case of shared spectrum, it may search for multiple strongest cells.

Since the best cell of a WTRU may not be the best for another WTRU due to different channel conditions, WTRUs performing measurements for dedicated and shared spectrum may measure and collect information on multiple cells.

If WTRU B is not able to perform the distributed task and report in required time, it may send an indication to decline the request. The non-ability may be determined by conflicting requests or procedures, conflicts in resource availability to send the report, or low battery levels.

WTRU B reports its cell scanning results to WTRU A 1509.

WTRU B may determine the list of cells to report, based on the collaborative cell selection configuration (see step 1). As an example, reporting all the cells of the selected PLMN satisfying the S criteria, and that are not barred for WTRU A based on WTRU A's information if available at WTRU B.

The report, based on the configuration of the collaboration, may include RSRP/RSRQ, L1 measurement, Cell ID, PLMN, cell category (e.g., barring/reserved info), MIB information, SSB information, frequency, and timing to find the cell.

WTRU A may evaluate the cell selection criteria with the received measurements and select a cell to camp on 1510.

To verify the suitability, the WTRU may check the cell selection criteria. Typical criteria may be modified in the case of collaborative cell selection, and the criteria and its parameters may be part of the collaborative cell selection configuration:

The WTRU may need to check if the cell is barred for collaboration, where the information can be obtained from the latest known information provided by NAS or by the information provided by the assisting WTRU. If the cell is barred, the WTRU should not consider it as suitable. The WTRU may also check whether the cell is barred for itself, based on the received information.

Evaluate the cell selection criteria for collaboration: When evaluating the S, Srxlev and Squal criteria based on another user's measurement, a bias may be applied by the WTRU to account for the potential difference in measurement that the WTRUs would experience. This bias may be one or more offsets added in the definition of Srxlev and Squal. Note that alternatively, the offsets can be applied either to the measurement itself instead of the criteria.

The offset determination may be based on (pre)configuration, e.g., given by the network or exchanged between WTRUs, and may be determined by the WTRU evaluating the measurement based on the WTRU information exchange and measurement report as follow (note that the following are non-limiting and can be applied in combination):

Distance-based offset: This offset may be determined depending on the distance between the collaborating WTRUs. Several offset values may be configured and be selected based on configured distance thresholds. Typically, a OdB offset would apply if the WTRUs are collocated, a 3 dB can apply for WTRUs when the distance is below a first distance threshold, 5 dB between the first and second distance threshold, etc. These values are non-limiting examples. Note that the distance metric can be replaced by evaluating the pathloss between the WTRUs. The collocated/distance aspect can be estimated using the connectivity, e.g., long-range wireless vs. very short-range wireless/wired systems.

Capability-based offset: This offset may be determined depending on the difference of selected capabilities between the WTRUs. If the assisting WTRU uses beamforming with 4 RX antennas, while the assisted WTRU only has 2 RX antennas for beamforming, the offset may be configured to 3 dB. The possible combinations of beam capabilities/number of antennas are configured and then selected by the WTRU based on the exchanged WTRU information.

Role-based offset: this offset may be determined by the role of the collaborative WTRU in the group, e.g., if the WTRU is a coordinator or a relay/gateway or a primary WTRU. This offset may be set to prioritize the grouping WTRUs with that collaborative WTRU.

Measurement delay based: This offset may be determined based on the time between the measurement—indicated with the measurement report, and the evaluation. For instance, if the delay is below a first threshold, no offset applied; if between the first and second threshold, a 3 dB offset applies, and so on.

If the selected cell was not (recently) scanned by WTRU A, it may first verify that the cell is present and suitable before camping on it.

WTRU A may report the selected cell to WTRU B 1511. The report may contain the cell information (cell ID, frequency, RAT, RSRP, etc.). WTRU B may consider reselecting to that cell as well as part of the collaboration, if it is configured to do so, or based on some reselection trigger. The report may be performed in the condition that the WTRU B is a coordinator, or if WTRU B is configured to receive the report.

WTRU A may report the selected cell to the network 1512, e.g., during NAS/location registration procedure, indicating that the selection has been performed using a collaborative selection (and the associated parameters and collaborative WTRU IDs/info), so that the network may keep track of collaboration between users, send collaboration specific parameters (e.g., via SIB) and update the configuration of the user based on the collaboration. For example, the network may configure the paging occasions for the WTRUs in the collaboration, send collaboration-specific parameters to both assisted and assisting WTRUs, etc.

Step 10 (1512) may be performed before step 9 (1511).

The WTRU may camp on the selected cell 1513, and may start monitoring the control channel, e.g., to receive SIBs and paging messages.

Regarding handling measurements from multiple assisting WTRUs, note that even if the steps are described for a WTRU B assisting a WTRU A, there may be multiple WTRU B that WTRU A selected for the cell scanning distribution (e.g., so that each WTRU has different a scanning assignment or that multiple WTRUs would perform overlapping assignments for redundancy and reliability of the collaboration results). Step 5 (1507) to step 7 (1509) may be applied to each of these WTRUs. In step 8 (1510), WTRU A may compare the received measurements to select the cell or can determine the cell selection based on a grouped criterion.

When multiple WTRUs report different measurements for a given cell, the assisted WTRU may use the determined list of WTRUs priority to down select the measurement for evaluation (i.e., use the measurement from the highest priority WTRU). Alternatively, it may be (pre)configured to select either the worse, best, or average measurement of them.

In one embodiment, the WTRU may evaluate the received measurements from the collaborative WTRUs and filter out the measurements or cells that are not suitable; then it may compare, for each remaining cell/frequency measurement, and including the bias, which cell is the strongest on each frequency, based on the multiple measurements; then it may select the cell e.g., the cell measured with the strongest RSRP (with bias). In the case where multiple measurements are similar (e.g., within a (pre)configured RSRP margin), the WTRU may rank the strongest cells based on determined WTRU priority list, and select the cell measured by the highest priority WTRU.

In another embodiment, the cell selection may be based on a group behaviour, i.e., not necessarily based on the strongest RSRP cell (with bias), but rather a cell that would help the WTRU as part of the collaboration group. Various methods for group behaviour may be considered.

As one example, if the strongest RSRP cell is a cell that was measured only by a single collaborative WTRU but another cell is measured suitable by several WTRUs in the group (or, e.g., if the collaborative WTRUs are already served by that cell), the WTRU may select it and view that cell as more reliable as part of a WTRU group. Although several criteria may be used for deciding which cell to prioritize depending on the number of WTRUs, one simple approach is to select the cell that most WTRUs in the group measured with the strongest RSRP value.

As another example, the WTRU may select a cell that best satisfies another WTRU in the group. The WTRU may be (pre)configured to select cells to follow a specific WTRU's selection/measurement. The specific WTRU may be a group coordinator or a relay/gateway or a primary WTRU, and the WTRUs in the group may benefit from being served by the same cell. In that case, the WTRU, receiving multiple measurements, may prioritize the cell with the strongest RSRP value received by that WTRU, e.g., in case of equally satisfying cell options.

This way of handling multiple received measurements may be applied not only for the cell selection, but also in solutions for PLMN selection and cell reselection procedures described herein.

As shown in FIG. 15, in one example, an assisted WTRU may initiate a collaborative cell selection. It may receive collaborative cell selection configuration and information on other WTRU's capability and status, such as their carrier support, battery level and location. The WTRU may check that it is enabled to perform the collaborative cell selection based on the configuration and its own status. The WTRU may determine how the other WTRUs share the cell selection scanning of time, frequency and channels based on the received WTRU information and configuration, such as their location. The WTRU may transmit to the other WTRUs the time and frequency information of the carriers and channel they have to perform the cell scanning. After receiving the report from the other WTRUs, the WTRU may select the cell to camp on based on its measurement and the reported measurements, by evaluating the cell selection criteria on biased RSRP/RSRQ measurements and thresholds, using a bias depending on the location (e.g., if not collocated) and/or capabilities of the assisting WTRU. The WTRU may further report the selected cell to the assisting WTRU and to the network. Finally, the WTRU may camp on the selected cell.

As shown in FIG. 15, in one example, an assisting WTRU may perform collaborative cell selection. It may receive collaborative cell selection configuration and information about the requesting WTRU. The WTRU receives a request from another WTRU to perform a collaborative cell selection, indicating the frequencies, time and beams to use for the cell scanning and reporting indication. If the WTRU is not able to perform the task requested and/or report in time, the WTRU may send a notification to decline the request. Otherwise, the WTRU scans the requested parts of time/frequency, determines the set of cells to be reported using the configuration and request, e.g., cells with the requested PLMNs, and reports it using the configured/indicated resources. The WTRU may receive an indication about the selected cell and store the information as part of the collaboration.

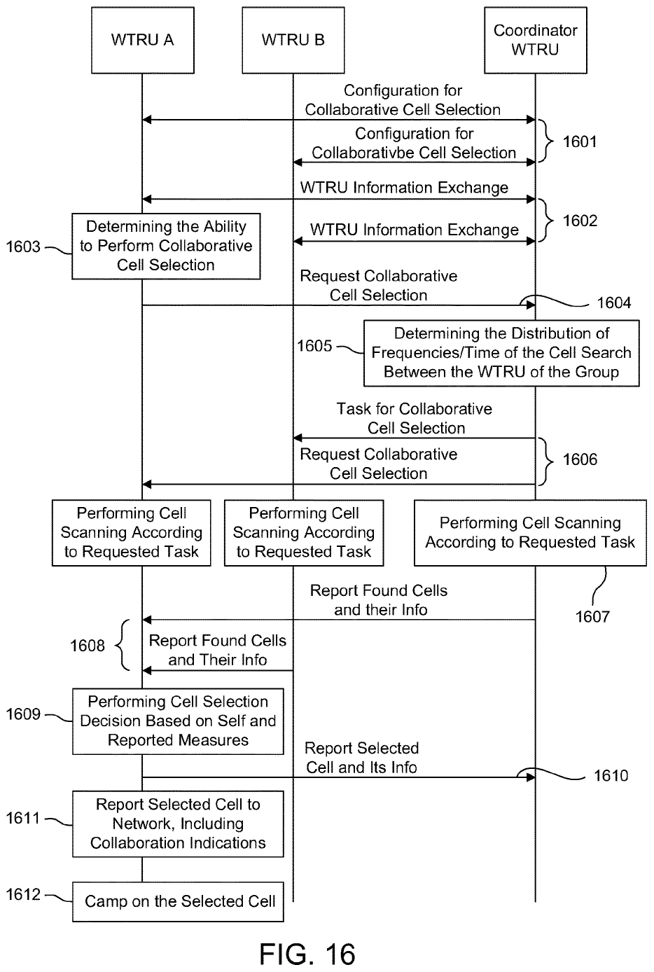

FIG. 16 illustrates a call flow of an example of a collaborative cell selection procedure for a WTRU with a coordinator WTRU.

In the case where the WTRU is in a group managed by a coordinator and it may be performing a collaborative cell selection, the collaborative cell selection procedure may include the coordinator that will receive the requests and determine the distribution of tasks.

1601 and 1602 are similar to the previous 1503 and 1504 in FIG. 15, but where the WTRUs may exchange the configuration and WTRU information through a coordinator that collects and forwards information to WTRUs in the group.

Additional/alternative indications can be exchanged to configure the role, ID, and resources for the coordinator.

1603 is similar to 1505 in FIG. 15.

In 1604, the WTRU sends the request for a collaborative cell selection procedure to the coordinator WTRU.

This request may include the desired carriers, RATs, PLMNs to be considered in the procedure.

1605 is similar to 1506 in FIG. 15, but performed by the coordinator WTRU.

1606 is similar to 1507 in FIG. 15, but sent from the coordinator WTRU side to the other WTRUs of the group. The task request can include the destination of the report, e.g., the requesting WTRU or coordinator information (ID, resources for report), based on the inter-WTRU connection status and the collaboration configuration.

1607 is similar to 1608 in FIG. 15.

In 1608, WTRUs reports to the requesting WTRU or to the coordinator, based on the configured information or the WTRU information received in 1606. When receiving reports from some WTRUs, the coordinator WRU forwards one or more of the reports to the requesting WTRU.

1609 is similar to 1510 in FIG. 15.

1610 is similar to 1511 in FIG. 15, but the WTRU sends the selected cell to the coordinator.

1611 is similar to 1512 in FIG. 15.

1612 is similar to 1513 in FIG. 15.

Alternatively, the coordinator WTRU may be the one performing the selection decision, and it may centralize the reports. In 1608, WTRUs may report the measurements to the coordinator WTRU. Then, the coordinator WTRU may perform 1609, 1610 (reporting to the assisted WTRU) and 1611.

Regarding embodiments for the coordinator, in one embodiment, a coordinator WTRU may receive collaborative cell selection configuration and information about other WTRUs' capabilities and statuses, such as their carrier support, battery level, and location. A coordinator WTRU may receive a collaborative cell selection request from a WTRU in the group, including carriers, RATs and PLMNs of interest. The coordinator WTRU may select and determine how the WTRUs share the cell selection scanning over the carriers, frequencies, and time domain, based on the received WTRU information and configuration, such as their location and battery status.

The WTRU may transmit to the selected WTRUs the time and frequency information of the carriers and channel they have to perform the cell scanning, as well as the requesting WTRU ID for reporting.

The coordinator WTRU may receive the report of some WTRUs, e.g., for those not directly connected to the requesting WTRU. The coordinator WTRU may aggregate the received reports and transmit them to the requesting WTRU. The coordinator WTRU may further receive the selected cell as part of the collaboration. Alternatively, the group may be configured to send their report to the coordinator, that aggregates the data and may also perform the cell selection, before sending the report to the requesting WTRU.

Regarding embodiments for the requesting/assisted WTRU, in one embodiment, a WTRU may initiate a collaborative cell selection. It first received collaborative cell selection configuration and information about other WTRU's capability and status, such as their carrier support, battery level and location. The WTRU may check that it is enabled to perform the collaborative cell selection based on the configuration and its own status. The WTRU may send a request to the coordinator for a collaborative cell selection, indicating the desired RAT, PLMN and carriers.

The WTRU may receive a request from the coordinator WTRU to perform part of the collaborative cell selection.

After receiving the report from the coordinator, the WTRU may select the cell to camp on based on its measurement and the reported measurements. It may further report the selected cell to the coordinator. Alternatively, the WTRU may receive the cell selection results from the coordinator if the coordinator is configured to perform the decision. The WTRU then may select and camp on the selected cell.

The collaborative cell selection for a WTRU is a procedure where a WTRU may select a cell with the assistance of other WTRUs. In this case, each WTRU in the group may select their own cell. There are occasions where it is desired to the WTRUs in a group select the same cell (i.e., camp on the same cell). In this case, a single cell may be selected. This is referred to a grouped cell selection.

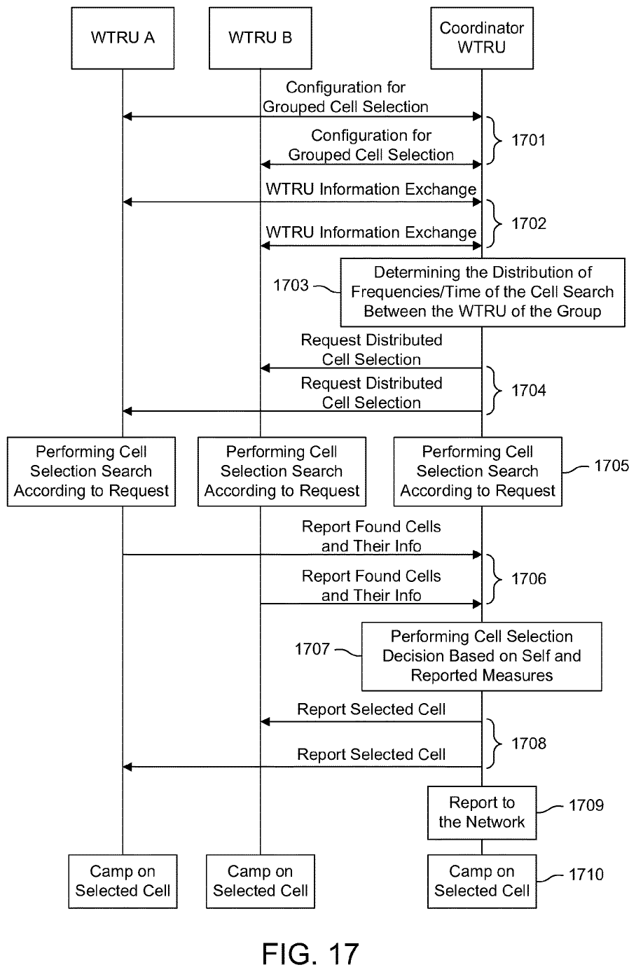

FIG. 17 illustrates a call flow of an example of a grouped and collaborative cell selection procedure with a coordinator WTRU.

The grouped and collaborative cell selection may be intended to be performed for/by a group of WTRUs. As a grouped selection, this procedure may be centralized in a coordinator WTRU. The coordinator WTRU may be one of the WTRU of the group itself.

The coordinator WTRU may request a group cell selection, where multiple WTRUs perform a grouped and collaborative cell selection. For instance, when a group of WTRUs is configured to be served by the same cell, the coordinator WTRU may be used to perform the selection for the group, aggregating measurements to select the best cell for the entire group.

Referring to FIG. 17, a group of WTRUs may exchange information to enable and configure the grouped, and collaborative cell selection 1701.

Additionally, the (pre)configuration may include criteria to trigger grouped cell selection, such as when the collaboration group is setup, when the coordinator is (re)selected, when a WTRU joins or leave the group, triggered by service/application/higher layer request.

Additionally, the configuration may include the grouped and collaborative cell selection criteria and parameters, such as priority criteria or offset criteria (see step 7).

WTRUs may exchange their information and status, based on collaborative cell selection configuration 1702.

The coordinator WTRU may trigger a grouped cell selection and determines how the cell selection should be distributed in the group 1703.

The trigger may be based on being the coordinator of a group with no connection; the WTRU being selected to be a coordinator for a group; having WTRUs joining or leaving the group.

The grouped cell selection may be triggered by a WTRU in the group that requests the coordinator for a (group) cell selection. If the group is configured to use a common cell, and the coordinator and users are capable of the grouped selection, the coordinator may proceed with a grouped cell selection, otherwise it falls back to a collaborative cell selection, i.e., procedure described in FIG. 16.

The coordinator WTRU may use the distance and WTRU spatial distribution for the grouped cell selection. For instance, when selecting a cell for the group, WTRUs may be in different places. The distance between WTRUs may be considered with a minimal threshold to select WTRUs for the scanning, to avoid duplicated/redundant measurements. E.g., collocated WTRUs may split the tasks orthogonally.

WTRUs with special roles/capabilities such as coordinators, relays/gateways, high-power or high class WTRUs may be considered to perform more tasks than other WTRUs such as RedCap, IoT, low-power devices.

The coordinator may transmit a collaborative cell selection request to WTRUs in the group, according to the configuration and including the scanning requirements 1704.

WTRUs may perform the cell scanning task 1705.

WTRUs may report their cell scanning results to the coordinator 1706 The report may follow the configuration of the distributed group cell selection.

For example, a WTRU may select all the suitable cells to be reported and may further report the list of cells that is measured but not suitable, e.g., due to failure to decode PBCH, or due to the cell being barred for the WTRU.

The coordinator may aggregate the measurements and the information from cell reports to select the cell to camp on for the group 1707.

The coordinator may exclude any measured or reported cell that is barred or forbidden for further selection.

The barred, reserved or forbidden status may be for the group, e.g., using a new “barring” indication (e.g., “cellBarredGroups” IE type: “barred” or “not barred”) that is defined and signalled in MIB or SIB1, where the barring indication targets groups or collaboration of users. When present and set to “barred”, a WTRU configured to be in a collaborative group considers this cell as barred.

The barring may be based on group ID or type of device (e.g., redcap devices).

The barred, reserved or forbidden status for the group may be considered when verifying if any WTRU in the group is not allowed on the cell, based on the WTRU information (e.g., categories) and the reported barring/reservation configuration.

Alternatively, the barred, reserved or forbidden status for the group may be considered when verifying if a specific WTRU in the group is not allowed, e.g., the coordinator, a relay/gateway or a configured necessary WTRU of the group, based on the WTRU information (e.g., categories) and the reported barring/reservation configuration.

WTRU information received by the coordinator may lead to the down-selection of a PLMN or set of PLMNs to be used for the group. Otherwise, if the PLMN was selected for the group, the coordinator may use the selected PLMN (and equivalent PLMNs).

The coordinator may exclude from the selection the cells whose PLMN is not in the selected PLMN or equivalent PLMNs.

The coordinator may aggregate the reported measurements from the WTRUs and checks the grouped cell selection criteria and ranking to select the best cell for the group.

To evaluate the cell quality of a link of a WTRU that did not measure a cell, the coordinator may use measurements from other WTRUs that are close to each other or collocated and estimate the link quality. For instance, a WTRU that did not measure a cell may be considered as using the measurement quantity of another WTRU in proximity (or collocated), adding an offset to account for the potential difference in link quality. The offset may be distance dependent or be based on the relation between other commonly measured cells by the two WTRUs.

The (pre)configuration of the grouped cell selection criteria may target selecting a cell that best satisfies the coordinator. The coordinator being a key WTRU of a group, its network connectivity is important to ensure communication between the network and the managing devices for the group. Thus, in this configuration, the measurements from the coordinator, or from the devices in proximity with the coordinator, may be considered with higher priority. The cell that maximizes the RSRP/RSRQ of the coordinator or its closely located WTRUs may be selected.

The (pre)configuration of the grouped cell selection criteria may target selecting a cell that best satisfies the relays. If present, relays/gateways to the network are also critical for the connectivity of the group. In this configuration, the measurements from the relays or from the devices in proximity with the relays can be considered with higher priority. The cell that maximizes the RSRP/RSRQ of the relay or its closely located WTRUs may be selected.

The (pre)configuration of the grouped cell selection criteria may target selecting a cell that best satisfies the maximum number of WTRUs. The coordinator may select the cell that maximizes the number of WTRUs that satisfy the S criteria. The sub-criteria Srxlev (RX level) and Squal (cell selection quality) can also be used with an additional configured offset to relax the constraints on cell selection.

The (pre)configuration of the grouped cell selection criteria may target selecting a cell that best minimizes the connectivity hops in the group to that cell. For instance, the coordinator may select the cell that would minimize the number of hops to the networks for the users in the group, using the inter-WTRU connection information and assuming that users would need to satisfy the S criteria to be able to be served by a cell.

When selecting the cell for a group of WTRUs, it may be possible that no cell satisfies all the WTRUs or group requirements. For example, in the case where a group is physically spread, and no one cell covers all the users. In that case, the coordinator may split the group of WTRUs into sub-groups, e.g., based on their location, and tries to perform a group selection for each subgroup.

The coordinator may report the selected cell to the group 1708.

The coordinator may report the results of the collaborative cell selection to the network, including the WTRUs that are in the group 1709.

The WTRUs in the group may camp on the selected cell 1710.

Regarding embodiments for the coordinator, in one embodiment, a coordinator WTRU may first receive group and collaborative cell selection configuration and information about other WTRU's capability and status, such as their carrier support, battery level, and location.

The coordinator WTRU may select and determine how the WTRUs share the cell selection scanning over the carriers, frequencies, and time domain, based on the received WTRU information and configuration, such as their location, battery status, and carrier/RAT capabilities.

The coordinator WTRU may transmit to the selected WTRUs the PLMN, time and frequency information of the carriers and channel they have to perform the cell scanning.

The coordinator WTRU may aggregate the received reports and select the cell for the group, i.e., select the cell that maximizes the number of users that would satisfy their S criteria based on received reports. The coordinator may split the group into subgroups for which it will select one cell. The coordinator may send the information on the selected cells to the WTRUs in the group.

A first WTRU may receive, from one or more WTRUs, capability and configuration information of the one or more WTRUs. The first WTRU may select a second WTRU from the one or more WTRUs for measurement collaboration. The first WTRU may send, to the second WTRU, a request for measurement collaboration. The first WTRU may receive, from the second WTRU, a measurement report with measurements of one or more cells. The first WTRU may determine a cell quality and suitability for the one or more cells. The determination may be based on an offset value. The first WTRU may select a cell, from the one or more cells, based on the determined cell quality and suitability. The first WTRU may camp on the selected cell.

Collaborative PLMN selection solutions.

On request from the NAS, the AS may perform a search for available PLMNs and report them to NAS. The WTRU may scan all RF channels in the NR bands (considering the 3GPP NR RAT) according to its capabilities to find available PLMNs and available CAGs. On each carrier, the WTRU searches for the strongest cell and read its system information, in order to find out which PLMN(s) the cell belongs to and any associated CAG(s).

The PLMNs of NR cells whose RSRP are measured above a threshold (−110 dBm, for example) may be reported as high-quality cells to the NAS. The PLMNs of NR cells whose RSRP are below but the PLMN was still decoded from the cell's system information may also be reported, along with their RSRP.

The PLMN selection may be performed when the WTRU turns on its radio, but also can be periodically performed when the selected PLMN is not the one with the highest priority, e.g., not the Home PLMN. If a higher-priority PLMN is found that satisfies the high-quality criteria, the higher-priority PLMN may be reselected by the NAS layer. In this context, the collaboration of a WTRU using sidelink can be done using either unlicensed or licensed bands (since the WTRU has the network configuration for sidelink on the attached cell).

Collaborative PLMN selection may use multiple devices of the group to distribute/offload part of the PLMN selection and channel scanning procedure. Different devices of the group may be responsible for a part of the scanning effort. This may parallelize and speed up the process, as well as save energy and processing to the devices.

The collaborative PLMN selection can be done for a group, i.e., so that the group may select one PLMN and a list of equivalent PLMNs; or so that the WTRUs in a group all share their resources to assist a given user to find one or more PLMNs (i.e., the WTRU may offload some aspects of its PLMN search to other's device).

The solutions may describe the collaborative PLMN selection between two devices as non-limiting examples. The solutions can be extended to multiple collaborative devices, and the receiving device may regroup/aggregate the multiple received reports using similar procedures.

SNPN selection may also be performed using the solutions described, for the WTRUs operating in SNPN access mode.

Collaborative PLMN selection may be intended to be performed by a group of WTRUs assisting one of the WTRUs in the group with tasks of scanning cells and selecting a cell for the one WTRU.

In this procedure, the inter-WTRU signalling may be carried through SL, or any established communication interface between the WTRUs such as Wi-Fi or Bluetooth. Not that for SL, as the PLMN selection is a step that may be performed before receiving the network configuration, the WTRUs may be required to use SL over unlicensed bands, typically using the Mode 2 resource allocation scheme. When using unlicensed bands, the communication between the WTRUs may experience delays or blockage due to collisions and retransmissions. In the present procedure however, the timing is not necessarily a very sensitive aspect, and the procedure can resume after successful transmissions.

In the case where the PLMN (re)selection is performed as part of a regular check for higher priority PLMN availability, the WTRU may already have the network configuration and may use SL over licensed bands.

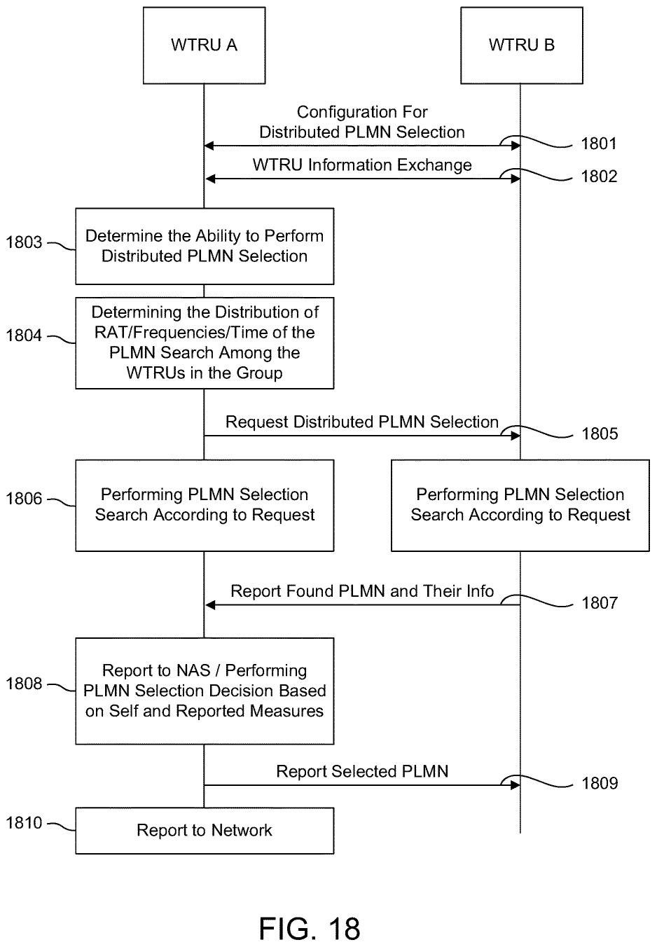

FIG. 18 illustrates a call flow of an example of a collaborative PLMN selection procedure for a WTRU with assistance of other WTRUs.

A group of WTRUs may exchange signalling to enable and configure the collaborative PLMN selection 1801. The WTRUs in the group may share the configuration that enables the collaborative PLMN selection for WTRUs. The configuration may be preconfigured, or shared using dedicated signalling between the WTRUs, e.g., using PC5-Collab.

The (pre)configuration may include the triggers and conditions to request the collaborative PLMN selection. For instance, a WTRU may request a collaborative PLMN selection when its battery level is low; or when the WTRU is at the cell edge or failed to find a PLMN in a previous attempt; or when there is a change in the WTRU collaboration group (e.g., a new assisting WTRU). The (pre)configuration may include parameters or offsets to use in the reporting and selection phases. The (pre)configuration may include the report content and criteria to select PLMNs for reporting. The PLMNs to be reported can include the set of high-quality PLMNs and other found PLMNs. The reports may be configured to include the PLMN, corresponding cell ID, corresponding frequency and channels, RSRP, RSRQ or RSSI values, SSB info, time and location of the measurement. The (pre)configuration may include the criteria and parameters to consider a PLMN as high-quality, such as the offsets for high-quality measurement from another device, depending on the distance and collocation of the devices.

The WTRUs may exchange their information and status, based on collaborative PLMN selection configuration 1802. The WTRUs may exchange their information, e.g., during the WTRU-to-WTRU individual connection configuration, group or collaboration configuration or on dedicated messages. Some of the information may be updated periodically or based on change of status triggers, such as battery status, connectivity updates, location updates. 1801 and 1802 are not necessarily in this order. Furthermore, 1802 may be split into multiple exchanges.

WTRU A may verify whether it is configured and enabled to perform a collaborative PLMN selection 1803. For example, WTRU A may request collaborative PLMN selection when its battery level is low; or when the WTRU is at the cell edge or failed to find a PLMN of high-quality in a previous attempt; or when there is a change in the WTRU collaboration group (e.g., a new assisting WTRU). Triggers for the PLMN selection may include when the WTRU turn on the Uu radio, or when the selected PLMN is not the highest priority PLMN, in which case a new selection attempt is performed regularly. The collaboration may be requested to be activated for regular (e.g., periodic) collaboration measurements or as a stand-alone collaboration. The periodic collaboration may be stopped when the WTRU successfully selected its highest priority PLMN.

WTRU A may select and determine which WTRUs will assist it and how the PLMN selection scanning task is distributed between the WTRUs 1804. The determination may be based on the received configuration and WTRU information. The determination may be based on the available RATs of the devices, where for example, different devices are configured to monitor different RATs, thus avoiding all the RATs from being turned on all the devices.

WTRU A may transmit a collaborative PLMN selection request to WTRU B 1805, according to the configuration and including the scanning requirements. This transmission may use the PC5-Collab interface, optionally using links dedicated for collaboration. The communication between the NAS layers of the WTRUs; or between the NAS and AS layers of the WTRUs; or between the AS layers of the WTRUs, may be e.g., via a newly defined PC5-Collab interface, or using the existing PC5-S, it may be at the RRC level (PC5-RRC), or MAC level (PC5-MAC), or PHY level (PC5-PHY).

The request may include the RATs, carriers, and channels to be scanned by the devices, as determined in 1804. The request may include a list of PLMN to be considered with higher priorities or to be reported. The request may include the timing information, if any, for the device to scan the indicated spectrum. The request may include the beamforming information, if any, for the device to scan the indicated spectrum. The request may indicate the maximum time or the occasions for the report to be transmitted.

WTRU B may perform the PLMN scanning task 1806 on their requested carriers and channels, time and beamforming, if any. If WTRU B is not able to perform the distributed task and report in required time, may send an indication to decline the request. The non-ability may be determined by conflicting requests or procedures, conflicts in resource availability to send the report or low battery levels.

WTRU B may report the found PLMNs to WTRU A 1807. This transmission may use the PC5-Collab interface to communicate between the NAS layers of the WTRUs; or between the NAS and AS layers of the WTRUs; or between the AS layers directly, e.g., at the RRC level. WTRU B may determine the list of PLMNs to report, based on the distributed PLMNs selection configuration 1801. As an example, WTRUs may be configured to report all the PLMNs satisfying the high-quality criteria and also may report PLMNs that have lower quality, with the corresponding measurements. The PLMNs with high-quality may also be reported with their signal strengths so that when a WTRU is sharing the found PLMN, other WTRUs may have information to better evaluate the measurement. The report contents may be based on the collaborative PLMN selection configuration, e.g., include the PLMN, corresponding cell ID, corresponding frequency, and channels, RSRP, RSRQ or RSSI values, SSB info, time and location of the measurement.

WTRU A access stratum (AS) may report the measurements to the NAS layer for the selection of the PLMN 1808. The AS layer of a WTRUs reports the PLMNs found to the NAS, including the high-quality PLMNs and the PLMNs that are not high-quality but detected, and with the corresponding measurements. The WTRU may have received reports from other WTRUs at the AS layer and will aggregate them before reporting to the NAS for selection. The WTRU may have received reports from other WTRUs at the NAS layer and will aggregate them at the NAS before selecting the PLMN.

The high-quality criteria for measurements reported by assisting WTRUs may be altered for the collaborative PLMN selection. The RSRP of measures made by assisting WTRUs used to evaluate the high-quality criteria may be modified with bias, e.g., offsets based on WTRU capabilities, location, connectivity.

In one embodiment, PLMNs measured by other WTRUs on frequencies that have not been scanned by the assisted WTRU may be added to the list of PLMNs found. An additional indication may be added that the measurement comes from another device in the group.

In one embodiment, PLMNs that have been found with high-quality on frequencies that have been scanned by the assisting WTRU, but the assisted WTRU did not measure it as high-quality, or if the assisted WTRU did not find that PLMN, the assisted WTRU may add it to the list of PLMNs, with an additional indication that the measurement comes from another device in the group.

The decision of the PLMN selection may be based on an aggregation of measurement from the device itself and reported measurements. For example, if a nearby WTRU measured the PLMN in a carrier that the WTRU did not scan, and that PLMN and/or carrier has a higher priority than the one the WTRU would select without the reported measurements, the WTRU may attempt to select that PLMN, or verify the link quality first, before selecting it, using the PLMN information received (e.g., frequency, cell ID, timing, etc.).

WTRU A may report the selected PLMN (including PLMN ID, frequency, RAT) to WTRU B as part of the collaboration 1809.

The WTRU may report the collaboration-based PLMN selection to the network 1810, e.g., during the NAS registration. Indicating the configuration of the collaboration, and the members of the group.

Note that there may be multiple WTRU Bs selected by WTRU A for the PLMN scanning distribution. 1805 to 18077 may then be applied to each of these WTRUs. 1808 may involve combining or comparing multiple measurements received from the different WTRUs.

A WTRU may be assisted by another WTRU to perform a collaborative PLMN selection. A WTRU may initiate a collaborative PLMN selection. It may first receive collaborative cell selection configuration and information about other WTRU's capability and status, such as their RAT and carrier support, battery level and location. The WTRU may check that it is enabled to perform the collaborative cell selection based on the configuration and its own status. The WTRU may determine how the other users of the group share the PLMN selection scanning of RATs, frequencies and channels based on the received user information, such as WTRU locations, and the configuration. The WTRU may transmit, to the other WTRUs, the time and frequency information of the carriers and channel they have to perform the cell scanning. After receiving feedback from other WTRUs, the WTRU may select the PLMN based on its measurement and the shared measurements, e.g., selecting a PLMN that was scanned by another WTRU scanning a different carrier. The WTRU may report the selected PLMN to the assisting WTRU.

A WTRU may assist another WTRU to perform a collaborative PLMN selection. A WTRU may first receive collaborative PLMN selection configuration and information about the requesting WTRU. The WTRU may receive a request from another WTRU to perform a collaborative cell selection, indicating the RATS, frequencies, time and beams to use for the PLMN scanning and reporting indication. If the WTRU is not able to perform the task requested and/or report in time, the WTRU may send a notification to decline the request. Otherwise, the WTRU may scan the requested parts of time/frequency, determine the set of PLMNs to be reported using the configuration and request, e.g., PLMNs with a high-quality measurement, and reports it using the configured/indicated resources. The WTRU may receive the selected PLMN by the assisted WTRU as part of the collaboration and may store the information.

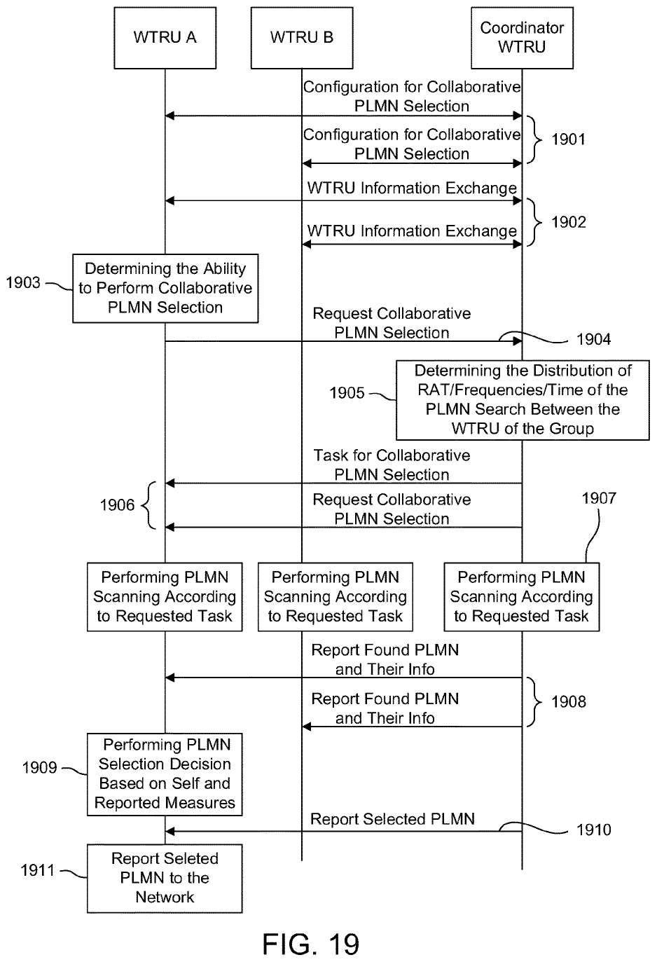

FIG. 19 illustrates a call flow of an example of a WTRU-initiated collaborative PLMN selection procedure with a coordinator WTRU.

In this example, an assisted WTRU (WTRU A) may initiate a collaborative PLMN selection. It may first receive, from the coordinator, collaborative PLMN selection configuration 1901. The coordinator may also share information about other WTRU's capability and status, such as their RAT and carrier support, battery level and location 1902. This process is similar to the one described for FIG. 18, except that here, the information is disseminated through the coordinator WTRU. The coordinator receives the information and forwards to one or more WTRUs in the group. Additional/alternative indications can be exchanged to configure the role, ID, and resources for the coordinator.

The assisted WTRU may verify that it is enabled to perform the collaborative PLMN selection 1903, based on the configuration and its own status. The assisted WTRU may determine how other users of the group share the PLMN selection scanning of RATs, frequencies and channels based on the received user information, such as WTRU locations, and the configuration. The assisted WTRU may transmit, to the coordinator WTRU, a request to execute collaborative PLMN selection 1904. This request may include the desired RATs, carrier frequencies and channels that may be considered in the procedure.

For instance, the WTRU may share, with the coordinator WTRU, the time and frequency information of the carriers and channel they have to perform the cell scanning. This may be shared via the coordinator WTRU, when the assisted WTRU sends the request for collaborative PLMN selection to the coordinator.

The coordinator WTRU may determine a task distribution 1905. The coordinator WTRU may schedule the tasks with the WTRUs 1906. All WTRUs, including the coordinator WTRU and the assisted WTRU, may be assigned tasks for the collaborative PLMN selection. The task request may include the destination of the report, e.g., the requesting WTRU or coordinator information (ID, resources for report), which may be based on the inter-WTRU connection status and configuration.

The WTRUs may perform the requested task 1907. The WTRUs may report the results to the assisted WTRU, either directly, or via the coordinator WTRU 1908. The results may include the PLMN information and the measurement results for one or more PLMNs.

After receiving feedback from other WTRUs, the assisted WTRU may select the PLMN based on its measurement and the measurements shared from the other WTRUs 1909. The assisted WTRU may select a PLMN that was scanned by another WTRU, which may have scanned a different carrier. The assisted WTRU may report the selected PLMN to the coordinator 1910, which may report to the assisting WTRU. The assisted WTRU may also report the selected PLMN to the network 1911. The assisted WTRU may perform its own cell selection based on the selected PLMN, or may trigger a collaborative cell selection procedure.

Alternatively, the WTRUs may be configured to send their measurements reports to the coordinator and the PLMN selection is performed at the coordinator WTRU side, which may report the selected PLMN to the requesting WTRU.

An assisting WTRU, assisting an assisted WTRU, may perform a collaborative PLMN selection It may first receive collaborative PLMN selection configuration and information about the assisted WTRU. The assisting WTRU may receive a request from another WTRU to perform a collaborative cell selection, indicating the RATs, frequencies, time and beams to use for the PLMN scanning and reporting indication. If the assisting WTRU is not able to perform the task requested and/or report in time, the assisting WTRU may send a notification declining the request. Otherwise, the assisting WTRU may scan the channels in the requested time/frequency, determine one or more PLMNs to be reported using the configuration and request, e.g., PLMNs with a high-quality measurement, and report the PLMNs using the configured/indicated resources. The report may be sent directly to the assisted WTRU or via the coordinator WTRU. The assisted WTRU may receive the selected PLMN information by the assisted WTRU as part of the collaboration and may store the information.

After the measurements are reported from the assisting WTRUs 1908, the PLMN selection may be performed by the assisted WTRU, as described above, or may be performed by the coordinator WTRU.

In one embodiment, a WTRU may initiate a collaborative PLMN selection. The WTRUs in the group may first exchange collaborative PLMN selection configuration with the coordinator WTRU. The WTRUs in the group also exchange their information about their capability and status, such as their RAT and carrier support, battery level and location with the coordinator WTRU. The coordinator WTRU may receive a request from the assisted WTRU for collaboration for cell selection. The coordinator WTRU may select and determine how the WTRUs share the PLMN selection scanning over the carriers, frequencies, and time domain, based on the received WTRU information and configuration, such as their location and battery status. The coordinator WTRU may send a request for distributed PLMN selection to one or more WTRUs in the WTRU in the group, including carriers, RATs and PLMNs of interest.

The WTRU may transmit to the selected WTRUs the RAT, time and frequency information of the carriers and channel they have to perform the PLMN scanning, as well as the requesting WTRU ID for reporting.

The coordinator WTRU may receive the report of some WTRUs, e.g., for those not directly connected to the requesting WTRU. The coordinator WTRU may aggregate the received reports and transmit them to the assisted WTRU. The coordinator may receive an indication about the selected PLMN by the assisted WTRU and store the information. Alternatively, all WTRUs in the group may be configured to send their report to the coordinator, that aggregates the data and may also perform the PLMN selection, before sending the report to the requesting WTRU.

Similar to cell selection, a grouped and collaborative PLMN selection may be used so that all WTRUs select and use the same PLMN, the coordinator WTRU may perform a grouped, collaborative PLMN selection. The coordinator WTRU may be used to distribute the scanning of the PLMN selection to the group, aggregating measurements to select the PLMN for the group.

Groups may be configured to select the same PLMNs or to be on equivalent PLMNs, e.g., when the service requires to avoid roaming or requires the WTRUs to be served by the same cells.

This may refer to the case where multiple devices of a given user are grouping with each other, the user having generally one network subscription.

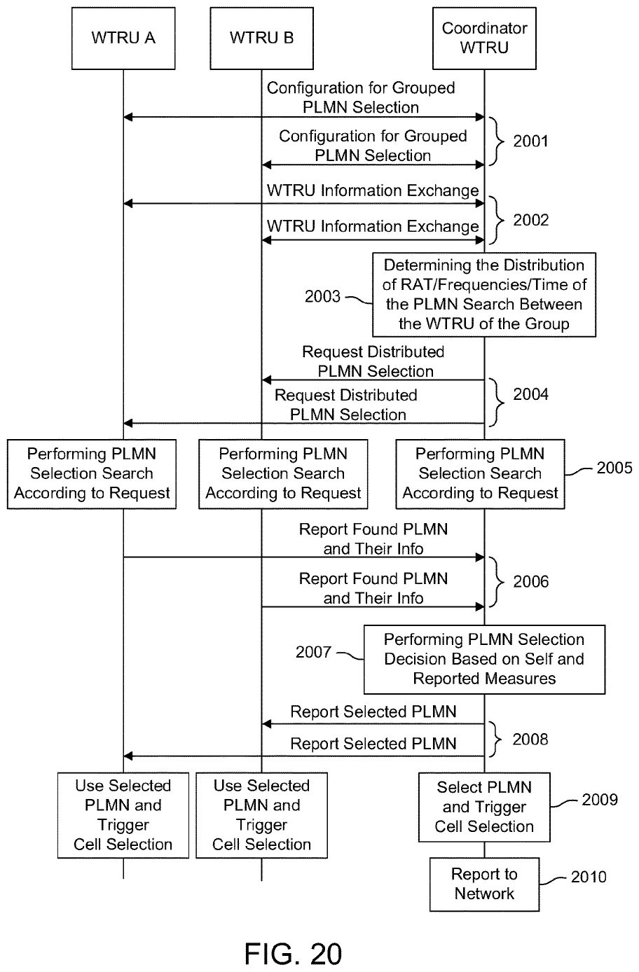

FIG. 20 illustrates a call flow of an example of a grouped and collaborative PLMN selection procedure with a coordinator WTRU.

A group of WTRUs may exchange information to enable and configure the grouped, collaborative PLMN selection 2001. The (pre)configuration may include criteria to trigger grouped PLMN selection, such as when the collaboration group is setup, when the coordinator is (re)selected, when a WTRU joins or leave the group, triggered by service/application/higher layer request. The (pre)configuration may include the grouped and collaborative PLMN selection criteria and parameters, such as priority or offset criteria.

WTRUs may exchange their information and status, based on collaborative PLMN selection configuration 2002. The WTRU information may also include the preferred PLMN or list of PLMN priority for the WTRUs (e.g., based on the Home PLMN (HPLMN), or list of equivalent HPLMNs (EHPLMNs).

The coordinator WTRU may aggregate the list of priorities of the PLMNs from the WTRUs and determine the priority of the PLMNs for the group. The (pre)configuration of the grouped PLMN selection criteria can target selecting a PLMN that:
1. Best satisfies the coordinator: The coordinator being a key WTRU of a group, its network connectivity is important to ensure communication between the network and the managing devices for the group. Thus, in this configuration, the PLMN priority (list) of the coordinator may be used as the priority (list) for the group.
2. Best satisfies the relays: In one example, relays/gateways to the network are also critical for the connectivity of the group. Thus, in this configuration, the PLMN priority (list) of the relays/gateways may be used as the priority (list) for the group.
3. Satisfies the maximum number of WTRUs. In one example, the coordinator may define the PLMN priority of the group can be based on the PLMN priority of the users, using the ranking PLMN for each user and establishing a new ranking, e.g., the PLMN with highest priority is the one that appeared the most in the top priority PLMN or equivalent PLMN of the users in the group.

After determining the list of priority for the group, the coordinator may send this priority list to the users, so they may use it to monitor PLMNs and share with their NAS.

The coordinator WTRU may trigger a grouped PLMN selection and determine how the cell selection should be distributed in the group 2003.

The trigger may be based on being the coordinator of a group with no connection; the WTRU being selected to be a coordinator for a group; having WTRUs joining or leaving the group.

The grouped PLMN selection may be triggered by a WTRU in the group that may request the coordinator for a grouped and collaborative PLMN selection. If the group is configured to use a common PLMN, and the coordinator and users are capable of the grouped selection, the coordinator may proceed with a grouped and collaborative PLMN selection, otherwise it may fall back to a collaborative PLMN selection.

In addition to the parameters used in collaborative PLMN selection, the coordinator WTRU may use the distance and WTRU spatial distribution in a different manner for the grouped PLMN selection for selecting and determining the WTRUs of the group and the distribution of the PLMN scanning tasks. For instance, when selecting a PLMN for the group, WTRUs may be in different places. The distance between WTRUs may be considered with a minimal threshold to select WTRUs for the scanning, to avoid duplicated/redundant measurements. E.g., collocated WTRUs may split the tasks orthogonally.

WTRUs with special roles/capabilities such as coordinators, relays/gateways, high-power or high class WTRUs may be considered to perform more tasks than other WTRUs such as RedCap, IoT, low-power devices.

The coordinator may transmit a grouped and collaborative PLMN selection request to WTRUs in the group, according to the configuration and including the scanning requirements 2004.

WTRUs may perform the PLMN scanning task 2005.

WTRUs may report their PLMN scanning results to the coordinator, similarly as in step 8 of FIG. 17.

The coordinator may aggregate the measurements and PLMN reports to select the PLMN and list of equivalent PLMNs for the group 2007.

The coordinator may aggregate the reported measurements from the WTRUs and checks the grouped PLMN selection criteria and ranking to select the PLMN and equivalent PLMNs for the group.

To evaluate the PLMN quality criteria of a link of a WTRU that did not measure a carrier, the coordinator may use measurements from other WTRUs that are close to each other or collocated and estimate the link quality. For instance, a WTRU that didn't measure a PLMN may be considered using the measurement quantity of another WTRU in proximity (or collocated), adding an offset to account for the potential difference in link quality. The offset may be distance dependent or be based on the relation between other commonly measured cells by the two WTRUs.

The (pre)configuration of the grouped PLMN selection criteria may target selecting a PLMN that:
1. Best satisfies the coordinator: In this configuration, the measurements from the coordinator or from the devices in proximity with the coordinator may be considered with higher priority. For instance, PLMN scanned with high-quality by the coordinator may be selected with a higher priority; or
2. Best satisfies the relays: In this configuration, the measurements from the relays or from the devices in proximity with the relays may be considered with higher priority. For instance, PLMN scanned with high-quality by the relays may be selected with a higher priority; or
3. Satisfies the maximum number of WTRUs: The coordinator may select the PLMN that maximizes the number of WTRUs that satisfy the high-quality criteria, and that supports the carriers where the PLMNs are present.

When selecting the PLMN for a group of WTRUs, it is possible that no PLMN satisfies all the WTRUs or group requirements. For example, in the case where some devices are not compatible with the carriers of other devices. In that case, the coordinator may split the group of WTRUs into sub-groups, e.g., based on their location/compatibility, and tries to perform a group selection for each subgroup.

The coordinator may report the PLMN selection to the group 2008.

The WTRUs in the group select the PLMN and trigger cell selection 2009.

The coordinator reports the collaborative PLMN selection to the network 2010.

A coordinator WTRU may first receive group and collaborative PLMN selection configuration and information from an assisted WTRU, capability and status, such as their RAT, carrier support, battery level and location and PLMN priorities. The coordinator WTRU may receive a collaborative PLMN selection request from a WTRU in the group, including carriers, RATs and PLMNs of interest. Or the initiation of a grouped and collaborative PLMN selection may be triggered by the coordinator WTRU itself (e.g., an internal request from NAS, AS or application layer). The coordinator WTRU may select and determine how the WTRUs share the PLMN selection scanning over the carriers, frequencies, and time domain, based on the received WTRU information and configuration, such as their location and battery status.

The assisted WTRUs may transmit to the selected WTRUs the RAT, time and frequency information of the carriers and channel they have to perform the PLMN scanning. Optionally, the coordinator WTRU may transmit the selected WTRUs the RAT, time and frequency information of the carriers and channel they have to perform the PLMN scanning. Optionally, it may be a combination of both depending on WTRUs' location and direct channel quality.

The coordinator WTRU may aggregate the received reports and select the PLMN for the group, e.g., establish the PLMN priority for the group based on WTRUs PLMN priority and select the PLMN that the maximum number of WTRUs would consider as high-quality, using extrapolated measurement between the devices. The coordinator may split the group into subgroups for which it will select one PLMN. The coordinator may send the selected PLMNs to the WTRUs in the group.

In addition to all the collaborative schemes discussed so far, the configuration and determination of the collaborative task distribution can be performed in a semi-static/periodic manner. In this case, the devices may avoid requesting collaboration for each PLMN (re)selection. For example, devices may be required to regularly check for a potentially higher PLMN frequency band to use.

The configuration and task distribution may indicate that the collaboration is to be performed on a regular basis, with timing indications, when necessary. The timing may be decided by the requesting/assisted WTRU or based on (pre)configuration, e.g., following existing timers that will run at all of the collaborating devices, at the same time. The other devices may then perform the collaborative distributed task on behalf of another, without a prior request (e.g., periodically) or with an activation/trigger request (e.g., a short message indication). The WTRUs then report their measurements to the initially requesting device.

The timing configuration for the regular check may be spread across different devices (e.g., different devices may perform the measurement corresponding to different scanning occasion, e.g., a round-robin between devices and/or the regular measurements may be split between different devices for different part of the spectrum.

When camping on a cell, a WTRU may perform cell reselection, where the goal may be to change the already selected cell to a cell that is either on a frequency of higher priority and/or a cell with stronger signal quality.

Issues related to WTRU collaboration for cell reselection and grouped reselection, may include:

How to perform collaborative/aggregated cell reselection and leverage other WTRUs measurement.

How to prioritize the cells/frequencies of the group to have the group on the same cell and avoid also reselecting a cell after selecting one based on collaboration/aggregation (e.g., due to a biased criteria).

Regarding group specific priority list handling, in an embodiment, the reselection is based on frequency/cell priority. Different rules and criteria apply to the measurements and triggers depending on the relative priority between the already selected cell frequencies and the others.

The priority list may be modified to prioritize a WTRU in a group (e.g., through collaboration or aggregation) to stay in the same cell/frequency.

In an embodiment, a WTRU may receive a cell reselection priority list for frequencies “cellReselectionPriority” from a WTRU in the group. Alternatively, the priority list may be obtained from the network, and it may be dedicated to the group or the WTRU (e.g., through RRC, the priority list may be the same for all WTRUs in the group). A frequencies priority list specific for the group may supersede a common priority list, e.g., received through SI. Using the group-specific priority list may allow the WTRUs in the group to share a common understanding of the priorities and apply the same rules, which may be beneficial to have WTRUs in the group regrouping towards the same frequencies. In addition, the cells supporting or dedicated to the group of WTRUs may also be treated as highest priority cells by the WTRU.

The frequency priority list may include, with highest priority, the frequencies that the group should use, e.g., frequencies of cells that the group supports or that are dedicated to the group of WTRUs.

In another embodiment, using a received frequency priority list as a baseline, the WTRU may update the frequency priority list to consider the frequencies reported as selected or reported as high priority by other WTRUs in the group as highest priority cells.

The cells supporting or dedicated to group of WTRUs may also be treated as highest priority cells by the WTRU.

When the WTRU updates the frequency priority list, due to received list from other WTRUs or to include the frequency of cells serving the WTRUs, the WTRU may report the list to the WTRUs in the group and to the network.

The group-specific frequency list priority may be used for the measurement rules for cell reselection to determine the frequencies on which to perform intra or inter-frequency measurements.

Regarding collaborative trigger for reselection, in a regular case, the WTRU may perform its own measurements for cell reselection, and may evaluate the serving cell using the measurement rules for cell reselection.

In the context of aggregation or collaboration, the measurement of the serving cell of the WTRU may be delegated to other WTRUs.

In an embodiment, the serving cell measurement may be triggered by the assisted WTRU and a measurement report may be received. The serving cell measurement may be requested on-demand or be set with periodic measurements. After receiving the report, the assisted WTRU may evaluate the rules for reselection and resume the reselection procedure.

In another embodiment, the WTRU may request the assisting WTRU to delegate its reselection evaluation and trigger. In this case, the assisted WTRU may indicate, to the assisting WTRU, their current serving cell (e.g., cell ID, frequency, RAT) and their frequency priority list. The assisting WTRU may then monitor the serving cell and evaluate the measurement rules for reselection for the frequencies in the priority list of the assisted WTRU. When the serving cell measurement gets below the thresholds for reselection, the assisting WTRU may report the reselection threshold to the assisted WTRU.

Alternatively, the assisted WTRU may indicates a threshold instead of its priority list, and the assisting WTRU compares the measurement to that threshold to trigger a reselection indication. The threshold may be determined by the assisted WTRU based on its priority list, configuration, and optionally, location of the WTRUs.

The report may include the trigger for reselection and the measurement of the serving cell (e.g., RSRP/RSRQ) and then the assisted WTRU shall determine the frequencies to perform the reselection measurements itself based on its priority list;

The report may include the trigger for reselection, the measurement of the serving cell (e.g., RSRP/RSRQ) and the list of frequencies to perform the reselection measurements, that the assisting WTRU based on the priority list received.

The assisted WTRU may perform the reselection measurement on the indicated frequencies.

To determine the list of frequencies to measure for the reselection, the WTRU may evaluate its serving cell measurement against the criteria for different frequency priorities.

To prioritize having the users of a group in the same cell or frequency, the WTRU may determine offsets that are used for the comparison of Srxlev to thresholds.

Different values of the offsets may be selected and configured for the WTRU.

Three offsets may be added for the criteria when determining is a condition is met such that the WTRU may preform intra-frequency measurements.

An offset may be for the intra-frequency criterion, when the WTRU's serving cell is the serving cell of the group. It may be preferred that all WTRUs have the same serving cell. In this case, the offset may be intended so that the criterion for triggering measurements is harder to pass. For instance, the offset may be added to the Srxlev condition: Srxlev<SintrasearchP-Offset1, where Offset1 is given in the configuration (e.g., 3 dB).

An offset may be for the intra-frequency criterion, when the WTRU's serving cell is not the serving cell of the group, but the group is served in that frequency. The offset may be intended so that the criterion for triggering reselection is easier to pass. E.g., Srxlev<SintrasearchP+Offset2, where Offset2 is given in the configuration (e.g., 3 dB).

An offset may also be used to evaluate the inter-frequency rules for the frequencies serving the group, e.g., to evaluate e.g., Srxlev<SintersearchP+Offset3, where Offset3 is given in the configuration (e.g., 3 dB). This may be used when the frequencies of the group are not already set to the highest priority.

The offsets may be different or may be the same. In intra-frequency case, an offset may be added to avoid searching/switching frequencies too frequently. The WTRU may prioritize the scanning of other cells in its frequency, i.e., trying to regroup into the same cell. For inter frequency, the WTRU prioritize staying in the same frequency, and not scan other frequencies. The network may configure the offsets according to the system conditions.

The offsets may be based on the configuration, and also based on the collaboration/group status. For instance, the offset may be different in the case where the serving cell was (re)selected using stand-alone measurement, collaborative measurement or aggregated measurement. The different values may be configured and selected by the WTRU, or alternatively, the network provides the offset based on the reported measurement type by the WTRU.

The measurements performed on the serving cell and other potential cells/frequency in the context of reselection may be performed using similar procedure. as described above for the collaborative or aggregated measurements, and additional measurement threshold or bias may be considered when determining whether or not the measurement may be performed.

Regarding reselection criterion and ranking for groups, after measuring the cells on the list of frequencies for reselection, the WTRU may select a cell based on reselection criterion.

To prioritize having the users of a group in the same cell or frequency, the WTRU may determine offsets that apply to the different frequencies/cells, depending on whether the group is served by that frequency/cell. The list of offsets may be based on the configuration received by the WTRU.

For instance:

It is known that, in general, a neighbour cell on a higher priority frequency may be selected if it fulfils the condition: Squal>Thresh_(X, HighQ) or Srxlev>Thresh_(X, HighQ).

The criteria with an offset may be: Squal>Thresh_(X, HighQ)+OffsetGroup_HighQ or Srxlev>Thresh_(X, HighP)+OffsetGroup_HighP. The new criteria may be used if the neighbour cell is serving the group.

It is known that a cell on a lower-priority frequency may be selected if it fulfils the condition Squal>Thresh_(X, LowQ) or Srxlev>Thresh_(X, LowP) in the general case. The criteria with an offset may be: Squal>Thresh_(X, LowQ)+OffsetGroup_LowQ or Srxlev>Thresh_(X, LowP)+OffsetGroup_LowP. The new criteria maybe used for the cell that is serving the group.

For cells in the same frequency as the serving cell or in the frequencies of the same priority, the ranking of cells that are serving the group may be biased using:

Rs=Qmeas, s+Qhyst-Qoffsettemp+Qoffsetgroup, if the serving cell is serving the group.

Rn=Qmeas, n-Qoffset-Qoffsettemp+Qoffsetgroup, if the neighbour cell is serving the group.

Rs may be used to rank a serving cell, Rn may be used to rank a neighbour cell, and Qhyst may be a hysteresis offset, which may be used to avoid changing cells too easily. The WTRU may select the cell with the highest rank R. Qoffsetgroup may be added only for the cells that serve the group, biasing the WTRU to select one of those cells.

The offsets may be based on the configuration, and/or based on the collaboration/group status. For instance, the offset may be different in the case where the serving cell was (re)selected using stand-alone measurement, collaborative measurement or aggregated measurement. The different values may be configured and selected by the WTRU, or alternatively, the network may provide the offset based on the reported measurement type by the WTRU.

The measurements performed on the serving cell and other potential cells/frequency in the context of reselection are possible to be performed using similar procedure as described above in the collaborative or aggregated measurements and applying additional measurement/threshold bias to consider that the measurement is not performed locally.

In one example, for collaborative cell/PLMN selection, a WTRU may be using another WTRUs measurement for its cell/PLMN selection. Two aspects are included:

Delegating the measurement to other WTRUs for cell or PLMN selection on its behalf, i.e., distribution of the task, requesting, receiving and using the measurement from another WTRU.

The measurements received and criteria may be biased to account for measurement uncertainty and difference between the devices.

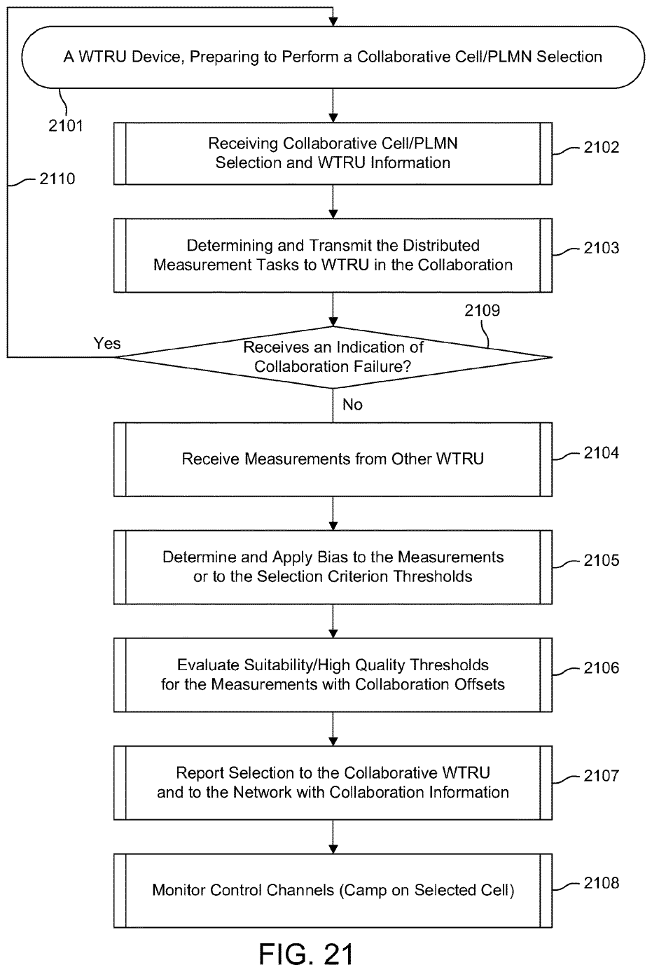

FIG. 21 illustrates a flow diagram of an example of a method for performing collaborative cell/PLMN selection.

A WTRU may be compatible and configured to receive WTRU information from a collaborating WTRU, and configurations from the network or from other WTRUs (e.g., using SL unlicensed, Wi-Fi or Bluetooth) 2101.

The WTRU information and status may include, e.g., WTRU capabilities, position, battery level information, capabilities of the inter-connection such as the PC5 radio interface, radio conditions, PC5 resource availability, etc.

The WTRU configuration may include collaboration triggers (e.g., based on coverage, energy levels), collaboration/aggregation specific thresholds and parameters (e.g., RSRP/RSRQ offsets) The WTRU may determine the distribution of the measurement tasks (e.g., RAT and frequency to be scanned) to assisting devices based on WTRU information (e.g., their capabilities) and the priority between the assisting devices 2103.

The WTRU may transmit the collaboration request, including the distributed measurement information (e.g., RAT, frequency, time and beams) for cell or PLMN selection to the corresponding devices. Use transmission timing and format based on the configuration, e.g., using unlicensed bands 2103.

The WTRU may receive the collaboration measurement report (e.g., RSRP and cell IDs) from other devices. Alternatively, receive an indication of collaboration failure and readjust distribution 2104.

The WTRU may determine the bias for evaluating the received measurement 2105, to account for the accuracy/capabilities difference, the locations of WTRU for the delay since measurement. For example: Add 3 dB bias because the WTRUs are not collocated and based on the received offset configuration; add 3 dB bias due to the WTRU having lower RX antennas capabilities than the assisting WTRU and according to the received offset configuration. The WTRU may be configured with the bias or may estimate the accuracy and determine the bias offset based on the estimated accuracy.

The WTRU may evaluate cell suitability and/or PLMN high-quality criteria, using received measurements, and based on collaboration-specific criteria, and the determined bias 2106.

The bias may be applied as an offset to the Srxlev/Squal or high-quality thresholds. Alternatively, the bias may be applied on the measurement instead of the criteria.

The WTRU may reject cells that are barred for collaboration or barred for the assisted WTRU, based on reported information.

In case of multiple assisting WTRU measurement received, the WTRU may use the determined assisting priority list to select one cell or one PLMN upon similar measurements. Alternatively, it may use a group selection criterion, e.g., select the cell/PLMN that has the strongest measurement value for the most assisting WTRUs.

The WTRU may camp on the selected cell and verify the suitability with self-measurements and information collection.

The WTRU may transmit, to the collaborative WTRU (i.e., the requesting WTRU), the selected cell information (e.g., cell ID, RAT, frequency) or PLMN (e.g., frequency, PLMN ID, RAT). Measurements may be added to the report 2107.

The WTRU may transmit, to the network, an indication of selected cell/PLMN and the collaboration information (e.g., group ID, collaborative WTRU ID), and including the offsets/bias used during the evaluation, e.g., through registration procedures 2108.

The WTRU may start to monitor control channels, e.g., to receive paging/SIB messages.

At any time, the WTRU may receive an indication of collaboration failure from an assisting WTRU. If there was only one assisting WTRU, or if all assisting WTRUs indicate collaboration failure 2109, the WTRU may restart the procedure 2110 and select a new WTRU to replace the one that failed.

Regarding a collaborative reselection trigger, a WTRU may rely on the group (e.g., collaboration) to measure the selected cell and report a reselection trigger when the cell measurements are lower than a threshold.

A WTRU may:
Transmit a request for collaborative measurement of the serving cell (e.g., including cell ID and frequency) for collaborative cell reselection to another WTRU.
Receive a report indicating the need for a cell reselection, including the measured quantity (e.g., RSRP/RSRQ)
Determine the frequencies on which to perform the reselection measurements, based on the frequency priority list and the received measurements.
The intra-frequency and inter-frequency criterion may add an offset to consider the collaborative measurement.
Trigger reselection measurements on the determined frequencies. Measurements may be obtained by the device itself or collaboratively performed or considering aggregation.

Alternatively, a WTRU may:
Receive or determine a frequency priority list.
Transmit a request for collaborative measurement of the serving cell (e.g., including cell ID and frequency) for collaborative cell reselection to an assisting WTRU, indicating the cell/frequency priority list to the assisting WTRU.
Receive a report indicating the need for a reselection, including the frequency to be measured and the measured quantity (e.g., RSRP/RSRQ), wherein:

The indication may be a list of frequencies, e.g., referring to the transmitted frequency priority list.

The indication may be categories of frequency (e.g., higher priority frequencies only, higher priority+intra-frequency or all frequencies).

Trigger reselection measurements on the indicated frequencies. Measurements may be obtained by the device itself or collaboratively performed or considering aggregation.

Examples of implementation of the collaboration functionality were provided in above paragraphs and illustrated in FIG. 6 to FIG. 12. Other implementations may be possible.

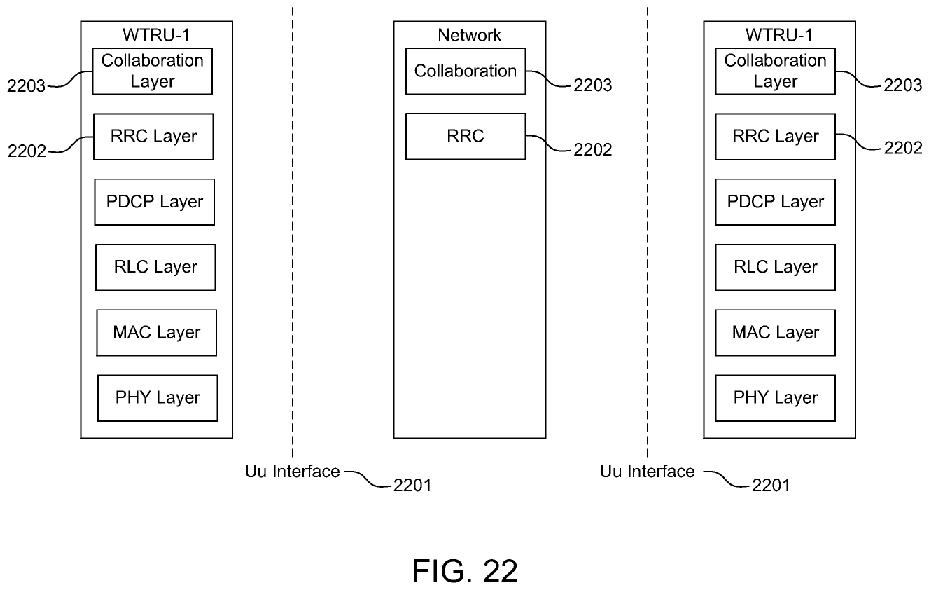

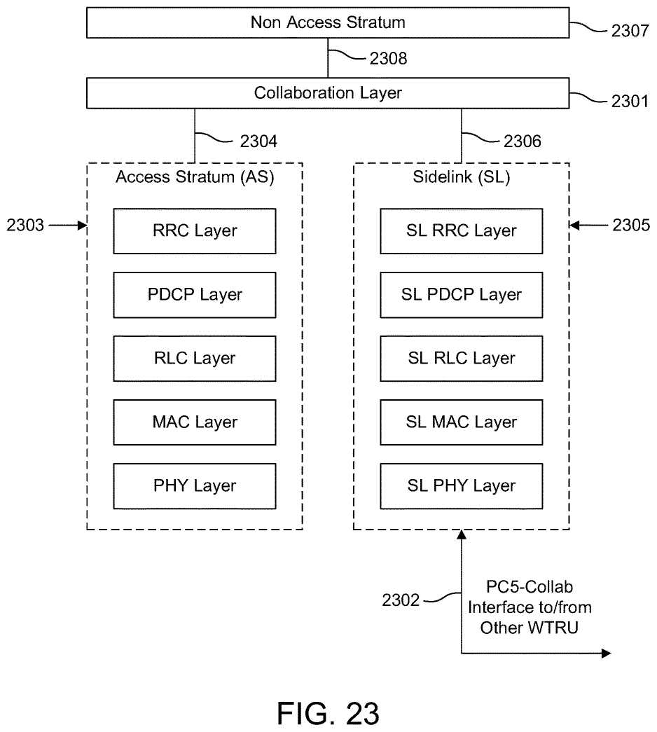

FIG. 22 illustrates an example of a control plane protocol stack implementation for collaboration via the Uu interface.

In this case, the WTRU may communicate to the network using the Uu interface 2201, sending requests and reports that support of the collaboration functionality; the network may then coordinate the delivery of such requests and reports to the associated WTRUs in the group. The functionality may be implemented as part of the existing RRC layer 2202 or via a new collaboration layer 2203.

As another example, the collaboration layer of each WTRU may be implemented to communicate with the collaboration layer of other WTRUs via the sidelink interface (PC5).

FIG. 23 illustrates an example of a control plane protocol stack implementation for collaboration via the PC5 interface.

This example is similar to the model presented in FIG. 7. In this example, the collaboration layer 2301 of the WTRUs may communicate with each other via the sidelink interface 2302 using the PC5-Collab interface.

In one example, the PC5-Collab interface may be a new defined dedicated interface to support the collaboration features. In another example, the collaboration layer may leverage the existing PC5-RRC interface and communicate using e.g., SL RRC messages. In another example, the collaboration layer may leverage the existing PC5-MAC interface and communicate using e.g., MAC Control Elements (MAC-CE). In another example, the collaboration layer may leverage the existing PC5-PHY interface and communicate using, e.g., sidelink control information (SCI). In another example, the communication between the collaboration layers may be performed using a newly defined PC5-Collaboration (PC5-Collab) interface. The PC5-Collab interface may be a dedicated interface, with dedicated messaging defined. The PC5-Collab interface may have dedicated links and SRBs to exchange collaboration information.

As the collaboration layer 2301 may support procedures that are run in the WTRU's Access Stratum (AS) 2303, such as, for example, cell selection and cell reselection, the WTRU's collaboration layer 2301 may communicate with the WTRU's AS 2303 and receive requests from and provide results to the WTRU's AS via an internal interface 2304. The collaboration layer 2301 may obtain the information need by the WTRU's AS 2303 from the sidelink stack 2305. The collaboration layer may communicate with the WTRU's sidelink via an internal interface 2306. As the collaboration layer 2301 may also support NAS procedures, the collaboration layer 2301 may interface with the NAS layer 2307 via an internal interface 2308. The WTRU's sidelink interface 2302 may then be utilized to send requests and receive results to and from other WTRUs, respectively.

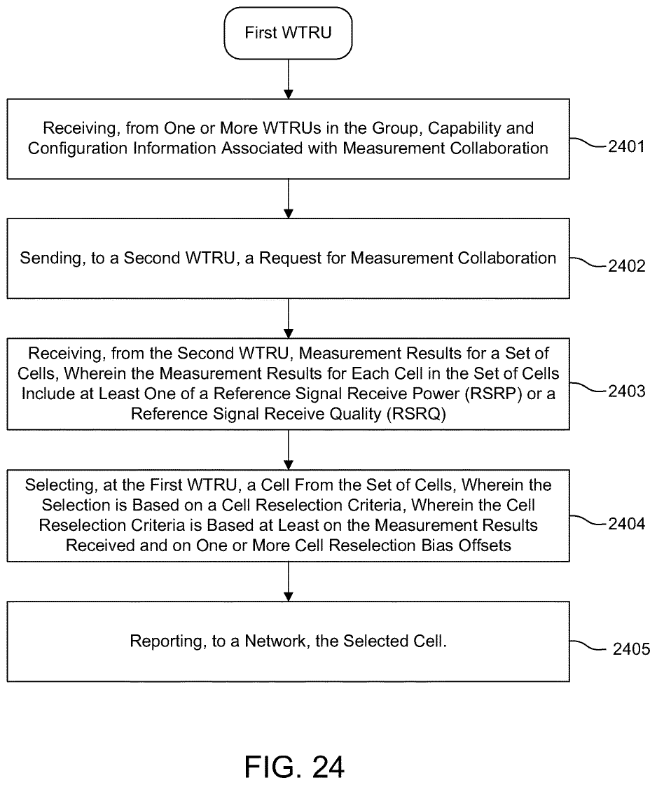

FIG. 24 illustrates an embodiment of a collaborative cell selection procedure for a first WTRU. The first WTRU may be configured to communicate in a group of a plurality of WTRUs in proximity of each other. The first WTRU may receive, from one or more WTRUs in the group, capability and configuration information associated with measurement collaboration 2401. The first WTRU may send, to a second WTRU, a request for measurement collaboration 2402. The first WTRU may receive, from the second WTRU, measurement results for a set of cells, wherein the measurement results for each cell in the set of cells include at least one of a Reference Signal Receive Power (RSRP) or a Reference Signal Receive Quality (RSRQ) 2403. The first WTRU may select a cell from the set of cells, wherein the selection is based on a cell reselection criterion, and wherein the cell reselection criterion is based at least on the measurement results received and one or more cell reselection bias offsets 2404. The first WTRU may report, to a network, the selected cell 2405.

Regarding cell reselection and group specific reselection priority handling and measurement rules, a WTRU adjusts the frequency priority list based on the group and uses the list to determine the frequencies to scan for cell reselection using offsets to prioritize the frequencies/cells used by the group.

During a cell selection or reselection process, a WTRU in a group of WTRUs may take into consideration information associated with the group, such as the group's serving frequency, serving cell, or the group's frequencies priorities. Details on the handling of measurements for cell selection and reselection and PLMN selection by a WTRU in group are discussed at length. Criteria for cell selection, cell reselection, and PLMN selection to be used by a WTRU in a group of WTRUs are described in details. Biases are introduced in procedures and criteria based on information associated with the WTRU's group.

Two aspects are included here: 1) Changing the priority list of the frequencies for reselection to prioritize the frequencies that are selected by the WTRUs in the group and 2) applying bias on measurement rules to determine which frequency should be measured.

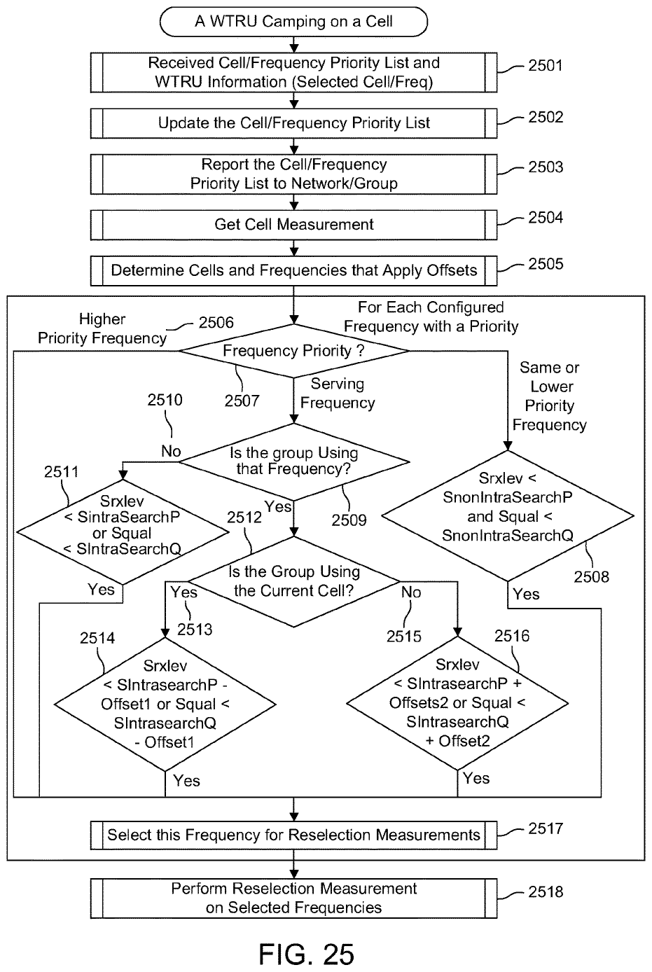

FIG. 25 illustrates a flow diagram of an example of measurements for cell selection and reselection by a WTRU in a group.

A WTRU may be camping on a cell. The WTRU may be part of a group. The WTRU may receive, from another WTRU in the group, a frequency priority list for cell reselection, and the cell(s) and frequency(ies) that are selected by the WTRUs in the group 2501. Alternatively, it may be sent from the network, or from the coordinator WTRU).

The WTRU may update the frequency priority list for cell reselection based on the received information 2502. For updating, the WTRU may consider the priority of each frequency to measure and compare with the priority of the frequency of the current (serving) cell. Frequencies supporting or dedicated to the WTRU group may be considered higher priority that the serving frequency. Frequencies selected by the group or by WTRUs in the group may also be considered higher priority than the serving frequency. All other frequencies may be considered lower priority than the serving frequency.

There may be indications in MIB/SIB of whether the cells supports (e.g., not barred) groups of collaborative WTRUs. Some cells may be dedicated to supporting collaborative WTRUs. The WTRU selecting a cell may consider the frequency of these cells with higher priority.

The WTRU may report the frequency priority list used to the network and to the WTRUs in the group 2503.

The WTRU may obtain measurements for the serving cell 2504. These measurements may be measurements generated by the WTRU or measurement results received from other WTRUs in the group. Based on the obtained serving cell measurements, the WTRU may evaluate the serving cell measurement against intra and inter-frequency selection criterion together with the previously determined frequency priority list 2501. Based on the evaluation, the WTRU may select the frequencies on which to perform measurements for the purposes of cell reselection 2505.

For frequencies with higher priority than the serving frequency 2506, the WTRU may select all the frequencies with higher priority than the serving frequency to trigger the reselection measurements.

For frequencies with lower priority than the serving frequency 2507, the WTRU may select all the frequencies with lower priority if the serving cell conditions Srxlev<SnonIntraSearchP or Squal<SnonIntraSearchQ are met 2508.

For intra-frequency measurements 2509, if the group is not using the serving frequency 2510, then the WTRU may select to measure that frequency if serving cell conditions Srxlev<SIntraSearchP or Squal<SintraSearchQ are met 2511. If the group is using the serving frequency 2512, then the WTRU may apply an offset to bias the measurement condition for cell reselection based on whether or not the group is using the same serving cell as the WTRU. This may bias the WTRU to remain in the current serving cell in case the current cell is also the serving cell for the group. In the other hand, it may bias the WTRU to consider a reselection to another cell if the current serving cell is not the serving cell for the group.

If all other WTRUs in the group are not served by the same cell, conditions may be relaxed to consider other factors such as the number (or a percentage) of WTRUs in the same serving cell, or the distance of the other WTRUs from the current WTRU, WTRUs velocity, or other factors for the triggering condition determination.

As an example, if the group served by the same serving cell 2513, or if other pre-defined condition is met, as described above, then the WTRU may verify if the serving cell criterion Srxlev<SIntraSearchP Offset1 or Squal<SIntraSearchQ-Offset1 is met, where Offset1 is a positive value in dB 2514. This condition of the serving cell, if met, may trigger measurements of other cells in the same frequency. The new criterion makes the condition less likely to be met, and, accordingly, it may be more likely that the WTRU will not trigger measurements and will stay in the same cell.

If the group is served by a different cell 2515, then the WTRU may verify if the serving cell criterion Srxlev<SIntraSearchP+Offset2 or Squal<SIntraSearchQ+Offset2 is met, where Offset2 is a positive value (in dB) 2516. For example, Offset1=3 dB, Srxlev<SIntraSearchP+3; which makes the condition more likely to be met and, accordingly, it may be more likely that the WTRU triggers neighbour cell measurements. This condition of the serving cell, if met, may trigger measurements of other cells in different frequencies.

Offset values may be configured by RRC or be pre-provisioned, or exchanged by the WTRUs via the PC5-Collab interface.

Once the frequencies for reselection measurements are chosen 2517, the WTRU may perform reselection measurements on the chosen frequencies 2518.

After measurements are performed, in a cell reselection case, the WTRU may decide whether or not to reselect to another cell. The WTRU may use a cell selection and reselection criterion and a cell ranking to determine which cell to camp on.

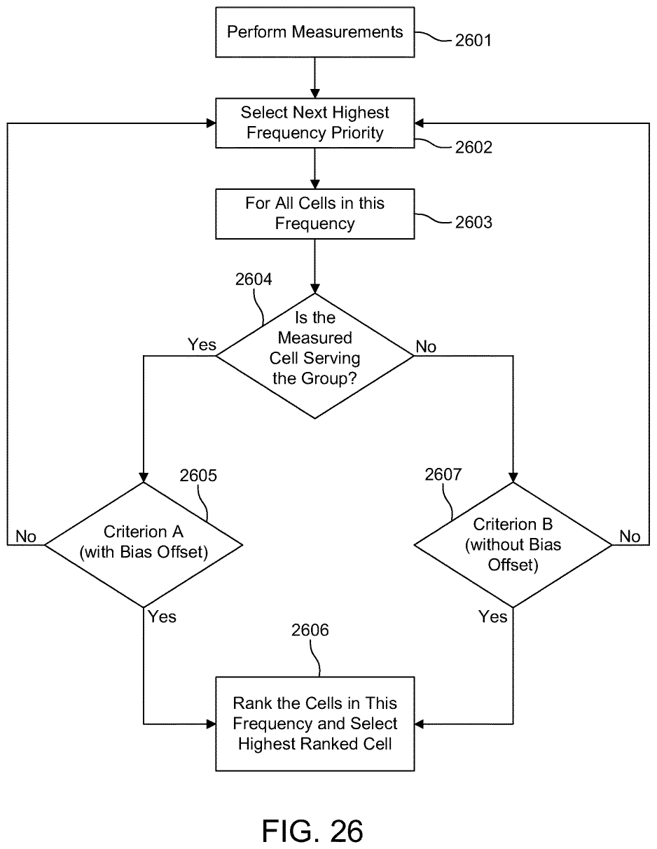

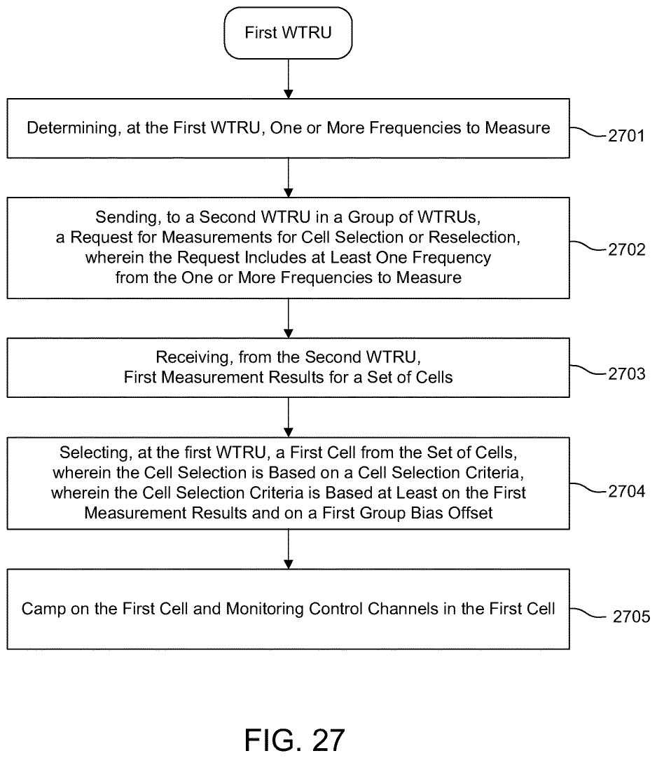

FIG. 26 illustrates a flow diagram of an example of cell selection and reselection criteria used by a WTRU in a group.

The WTRU may receive a configuration indicating the offset for reselection on inter (non-intra) and intra frequency for the cells in the group.

The WTRU may receive the indication of the cell(s) and frequency(ies) that may be selected by UEs in the group, from a WTRU in the group (or from the network).

The WTRU may perform measurements for cell reselection, as shown in FIG. 25. The WTRU may select a cell using a selection bias.

Based on the measurement results 2601, the WTRU may verify the criterion for reselection using bias.

Let F_S be the frequency of the WTRU's serving cell and F_G be the frequency of the cell serving the WTRUs in the group. Let P_S be the priority of the frequency of the WTRU's serving cell (F_S) and P_G be the priority of the frequency of the cell serving the WTRUs in the group (F_G).

The WTRU aims to select a measured cell which is of highest priority frequency. Accordingly, for each of the measured cells, and starting with the measured cell with the highest priority frequency, the WTRU may verify if the cell reselection criterion is met.

The WTRU may evaluate the measured cells, starting with the cells with the highest priority frequency.

Starting with the highest priority frequency 2602, the WTRU evaluates all cells in that frequency 2603. The WTRU may verify if the measured cell is serving the WTRUs in the group 2604.

For the measured cells serving the WTRUs in the group, the WTRU may verify if the measured cell fulfills the criterion with bias 2605:

Criterion A: Squal >Thresh_(X, HighQ)-OffsetGroup_HighQ or Srxlev >Thresh_(X, HighP) OffsetGroup_HighP.

If the criterion is fulfilled, the WTRU may select the measured cell. If more than one measured cell fulfills the criterion, then the WTRU may rank the measured cells:
Rn=Qmeas, n-Qoffset−Qoffsettemp, and choose the cell with the highest rank 2606.

If the measured cell is not serving the WTRUs in the group, then the WTRU may verify if the measured cell fulfills the criterion without the bias:
Criterion B: Squal>Thresh_(X, HighQ) or Srxlev>Thresh_(X, HighP) 2607.

If so, the reselection criterion is fulfilled for the measured cell and the WTRU may select this cell. If more than one cell fulfils the criterion, then the WTRU may rank the cells:
Rn=Qmeas, n-Qoffset—Qoffsettemp, and choose the cell with the highest rank 2605.

The WTRU may report the selected cell to the group.

The WTRU may report the selected cell to the network.

The WTRU may camp on the selected cell (e.g., monitoring control information such as broadcast information and paging information).

FIG. 27 illustrates one embodiment of the solutions described. A first WTRU may be in a group of WTRUs. The first WTRU may determine one or more frequencies to measure 2701. The first WTRU may send a request for measurements for cell selection or reselection to a second WTRU in the group 2702. The request may include at least one frequency from the one or more frequencies to measure. The first WTRU may then receive first measurement results for a set of cells from the second WTRU 2703. The measurement results may include each reported cell's RSRP and RSRQ. The first WTRU may select a cell from the set of cells 2704. The selection may be based on a cell selection criteria. The criteria may be based at least on the first measurement results received from the second WTRU and on a group bias offset. The selection criteria may also rely on measurement results generated at the first WTRU. The WTRUs in the group may maintain a list of frequencies and their priorities. The WTRUs may exchange the priority list periodically or upon a trigger or request. The WTRUs may update the list based on the exchanged information they may receive from other WTRUs in the group. The selection criteria may further rely on the frequencies priorities as per the latest (updated) priority list. The selection criteria may also be based on a cell rank. Cells may be ranked based on a ranking criteria, and the cell with highest priority frequency and highest rank in that frequency may be selected. The WTRU may camp on the selected cell and start monitoring the cell's control channels. The control channels may include the broadcast channel and the paging channel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of cell selection, the method performed by a first wireless transmit/receive unit (WTRU), the method comprising:
determining, at the first WTRU, one or more frequencies to measure;
sending, to a second WTRU in a group of WTRUs, a request for measurements for cell selection or reselection, wherein the request includes information indicating at least one frequency from the one or more frequencies to measure;
receiving, from the second WTRU, first measurement results for a set of cells;
selecting, at the first WTRU, based on cell selection criteria, a cell from the set of cells, wherein the cell selection criteria are based at least on the first measurement results and on a first group bias offset, wherein the first group bias offset biases selection of cells that operate on a same frequency as a frequency used in one or more cells serving the WTRUs in the group of WTRUs; and
camping on the cell and monitoring control channels in the cell.

2. (canceled)

3. The method of claim 1, wherein the one or more frequencies to measure included in the request to measure are based at least on a second group bias offset.

4. The method of claim 3, wherein the second group bias offset prioritizes one or more frequencies of one or more cells serving the WTRUs in the group of WTRUs.

5. The method of claim 1, wherein the control channels include at least a paging channel.

6. The method of claim 1, wherein the cell selection criteria are further based on second measurement results, wherein the second measurement results are generated at the first WTRU and include measurement results for one or more cells in at least one frequency from the one or more frequencies to measure.

7. The method of claim 1, wherein the cell selection criteria are further based on cell ranking, wherein the cell ranking is based at least on a third group bias offset.

8. The method of claim 1, further comprising, reporting, to the second WTRU, the cell.

9. The method of claim 1, wherein the first group bias offset is configured in the first WTRU based on a received radio resource control (RRC) message.

10. The method of claim 1, further comprising, receiving, from the second WTRU, first frequency priorities including one or more frequencies and their associated priorities.

11. A first wireless transmit-receive unit (WTRU), the first WTRU comprising at least one processor and a transceiver, wherein the at least one processor and transceiver are configured to:
determine, at the first WTRU, one or more frequencies to measure;
send, to a second WTRU in a group of WTRUs, a request for measurements for cell selection or reselection, wherein the request includes information indicating at least one frequency from the one or more frequencies to measure;
receive, from the second WTRU, first measurement results for a set of cells;
select, at the first WTRU, based on cell selection criteria, cell from the set of cells, wherein the cell selection criteria are based at least on the first measurement results and on a first group bias offset, wherein the first group bias offset biases selection of cells that operate on a same frequency as a frequency used in one or more cells serving the WTRUs in the group of WTRUs; and
camp on the cell and monitor control channels in the cell.

12. (canceled)

13. The WTRU of claim 11, wherein the one or more frequencies to measure included in the request to measure are based at least on a second group bias offset.

14. The WTRU of claim 13, wherein the second group bias offset prioritizes one or more frequencies of one or more cells serving the WTRUs in the group of WTRUs.

15. The WTRU of any one of claim 11, wherein the control channels include at least a paging channel.

16. The WTRU of claim 11, wherein the cell selection criteria are further based on second measurement results, wherein the second measurement results are generated at the first WTRU and include measurement results for one or more cells in at least one frequency from the one or more frequencies to measure.

17. The WTRU of claim 11, wherein the cell selection criteria are further based on cell ranking, wherein the cell ranking is based at least on a third group bias offset.

18. The WTRU of claim 11, wherein the at least one processor and the transceiver are further configured to report to the second WTRU, the first cell.

19. The WTRU of claim 11, wherein the first group bias offset is configured in the first WTRU based on a received radio resource control (RRC) message.

20. The WTRU of claim 11, wherein the at least one processor and the transceiver are further configured to receive, from the second WTRU, first frequency priorities including one or more frequencies and their associated priorities.
